(19) United States
(12) Patent Application Publication
(10) Pub. No.: US 2026/0213814 A1
(43) Pub. Date: Jul. 23, 2026

(54) CHANNEL STATE INFORMATION PROCESSING UNIT TIME DURATION FOR MODEL INFERENCE

(71) Applicant: Nokia Technologies Oy, Espoo (FI)

(72) Inventors: Keeth Saliya Jayasinghe LADDU, Espoo (FI); Andrea BONFANTE, Massy (FR)

(21) Appl. No.: 19/446,610

(22) Filed: Jan. 12, 2026

(30) Foreign Application Priority Data
Jan. 22, 2025 (EP) 25153219.8

(51) Int. Cl. H04B 7/06

(52) U.S. Cl. CPC H04B 7/0626

(57) ABSTRACT

Example embodiments of the present disclosure are directed to channel state information (CSI) processing unit (CPU) time duration for model inference. In a method, a first apparatus receives, from a second apparatus, a configuration of a CSI report based on an inference of a machine learning functionality. The configuration includes a set of resources for channel measurement. The first apparatus determines the CSI report based on the configuration, The CSI report occupies a set of CPUs for a time duration for the inference.

### CROSS-REFERENCE TO RELATED APPLICATION

This application claims priority from, and the benefit of EP Application Serial No. 25153219.8, filed Jan. 22, 2025, the contents of which are hereby incorporated by reference in their entirety.

### FIELD

Various example embodiments of the present disclosure generally relate to the field of telecommunication and in particular, to methods, devices, apparatuses and computer readable storage medium for channel state information (CSI) processing unit (CPU) time duration for model inference.

### BACKGROUND

A communication network may serve as a facility that enables communications between two or more communication devices or provides communication devices access to a data network. A mobile or wireless communication network is one example of a communication network. A communication device may be provided with a service by an application server.

As communication networks and services increase in size, complexity and number of users, operations in the communication networks become increasingly complicated. To improve the communication performance, machine learning (ML)/artificial intelligence (AI) technology is proposed to be used in the wireless communication networks. The AI/ML model may be applied to different communication functionality in different scenarios, including but not limited to, beam management (BM), CSI compression, positioning, and the like.

### SUMMARY

In a first aspect of the present disclosure, there is provided a first apparatus. The first apparatus comprises at least one processor; and at least one memory storing instructions that, when executed by the at least one processor, cause the first apparatus to: receive, from a second apparatus, a configuration of a CSI report based on an inference of a machine learning functionality, the configuration comprising a set of resources for channel measurement; and determine the CSI report based on the configuration, where the CSI report occupies a set of CPUs for a time duration for the inference.

In a second aspect of the present disclosure, there is provided a second apparatus. The second apparatus comprises at least one processor; and at least one memory storing instructions that, when executed by the at least one processor, cause the second apparatus to: transmit, to a first apparatus, a configuration of a CSI report based on an inference of a machine learning functionality, the configuration comprising a set of resources for channel measurement, where the CSI report occupies a set of CPUs of the first apparatus for a time duration for the inference.

In a third aspect of the present disclosure, there is provided another first apparatus. The first apparatus comprises at least one processor; and at least one memory storing instructions that, when executed by the at least one processor, cause the first apparatus to: receive, from a second apparatus, a configuration of an aperiodic CSI report based on an inference of a machine learning functionality, the configuration comprising a set of resources for channel measurement; receive, from the second apparatus, a message triggering the CSI report; and determine the CSI report based on the configuration, where the CSI report occupies a first set of CPUs for a first time duration for channel measurement, and where the CSI report occupies a second set of CPUs for a second time duration for the inference, the first set of CPUs being different from the second set of CPUs, and the second time duration being different from the first time duration.

In a fourth aspect of the present disclosure, there is provided another second apparatus. The second apparatus comprises at least one processor; and at least one memory storing instructions that, when executed by the at least one processor, cause the second apparatus to: transmit, to a first apparatus, a configuration of an aperiodic CSI report based on an inference of a machine learning functionality, the configuration comprising a set of resources for channel measurement; and transmit, to the first apparatus, a message triggering the CSI report, where the CSI report occupies a first set of CPUs of the first apparatus for a first time duration for channel measurement, and where the CSI report occupies a second set of CPUs of the first apparatus for a second time duration for the inference, the first set of CPUs being different from the second set of CPUs, and the second time duration being different from the first time duration.

In a fifth aspect of the present disclosure, there is provided another first apparatus. The first apparatus comprises at least one processor; and at least one memory storing instructions that, when executed by the at least one processor, cause the first apparatus to: receive, from a second apparatus, a configuration of a periodic or semi-persistent CSI report based on an inference of a machine learning functionality, the configuration comprising a set of resources for channel measurement and a CSI inference resource; and determine the CSI report based on the configuration, where the CSI report occupies a first set of CPUs for a first time duration for channel measurement, and where the CSI report occupies a second set of CPUs for a second time duration for the inference, the first set of CPUs being different from the second set of CPUs, and the second time duration being different from the first time duration.

In a sixth aspect of the present disclosure, there is provided another second apparatus. The second apparatus comprises at least one processor; and at least one memory storing instructions that, when executed by the at least one processor, cause the second apparatus to: transmit, to a first apparatus, a configuration of a periodic or semi-persistent CSI report based on an inference of a machine learning functionality, the configuration comprising a set of resources for channel measurement and a CSI reference resource; and transmit, to the first apparatus, a configuration of at least one target occasion of at least one resource for channel measurement, where at least one of a first time duration or a second time duration is based on the configuration of the at least one target occasion, where the CSI report occupies a first set of CPUs of the first apparatus for the first time duration for channel measurement, and where the CSI report occupies a second set of CPUs of the first apparatus for the second time duration for the inference.

In a seventh aspect of the present disclosure, there is provided a method. The method comprises: receiving, at a first apparatus from a second apparatus, a configuration of a CSI report based on an inference of a machine learning functionality, the configuration comprising a set of resources for channel measurement; and determining the CSI report based on the configuration, where the CSI report occupies a set of CPUs for a time duration for the inference.

In an eighth aspect of the present disclosure, there is provided a method. The method comprises: transmitting, at a second apparatus to a first apparatus, a configuration of a CSI report based on an inference of a machine learning functionality, the configuration comprising a set of resources for channel measurement, where the CSI report occupies a set of CPUs of the first apparatus for a time duration for the inference.

In a ninth aspect of the present disclosure, there is provided another method. The method comprises: receiving, at a first apparatus from a second apparatus, a configuration of an aperiodic CSI report based on an inference of a machine learning functionality, the configuration comprising a set of resources for channel measurement; receiving, from the second apparatus, a message triggering the CSI report; and determining the CSI report based on the configuration, where the CSI report occupies a first set of CPUs for a first time duration for channel measurement, and where the CSI report occupies a second set of CPUs for a second time duration for the inference, the first set of CPUs being different from the second set of CPUs, and the second time duration being different from the first time duration.

In a tenth aspect of the present disclosure, there is provided another method. The method comprises: transmitting, at a second apparatus to a first apparatus, a configuration of an aperiodic CSI report based on an inference of a machine learning functionality, the configuration comprising a set of resources for channel measurement; and transmitting, to the first apparatus, a message triggering the CSI report, where the CSI report occupies a first set of CPUs of the first apparatus for a first time duration for channel measurement, and where the CSI report occupies a second set of CPUs of the first apparatus for a second time duration for the inference, the first set of CPUs being different from the second set of CPUs, and the second time duration being different from the first time duration.

In an eleventh aspect of the present disclosure, there is provided another method. The method comprises: receiving, at a first apparatus from a second apparatus, a configuration of a periodic or semi-persistent CSI report based on an inference of a machine learning functionality, the configuration comprising a set of resources for channel measurement and a CSI inference resource; and determining the CSI report based on the configuration, where the CSI report occupies a first set of CPUs for a first time duration for channel measurement, and where the CSI report occupies a second set of CPUs for a second time duration for the inference, the first set of CPUs being different from the second set of CPUs, and the second time duration being different from the first time duration.

In a twelfth aspect of the present disclosure, there is provided another method. The method comprises: transmitting, at a second apparatus to a first apparatus, a configuration of a periodic or semi-persistent CSI report based on an inference of a machine learning functionality, the configuration comprising a set of resources for channel measurement and a CSI reference resource; and transmitting, to the first apparatus, a configuration of at least one target occasion of at least one resource for channel measurement, where at least one of a first time duration or a second time duration is based on the configuration of the at least one target occasion, where the CSI report occupies a first set of CPUs of the first apparatus for the first time duration for channel measurement, and where the CSI report occupies a second set of CPUs of the first apparatus for the second time duration for the inference.

In a thirteenth aspect of the present disclosure, there is provided a first apparatus. The first apparatus comprises means for receiving, from a second apparatus, a configuration of a CSI report based on an inference of a machine learning functionality, the configuration comprising a set of resources for channel measurement; and means for determining the CSI report based on the configuration, where the CSI report occupies a set of CPUs for a time duration for the inference.

In a fourteenth aspect of the present disclosure, there is provided a second apparatus. The second apparatus comprises means for transmitting, to a first apparatus, a configuration of a CSI report based on an inference of a machine learning functionality, the configuration comprising a set of resources for channel measurement, where the CSI report occupies a set of CPUs of the first apparatus for a time duration for the inference.

In a fifteenth aspect of the present disclosure, there is provided another first apparatus. The first apparatus comprises means for receiving, from a second apparatus, a configuration of an aperiodic CSI report based on an inference of a machine learning functionality, the configuration comprising a set of resources for channel measurement; means for receiving, from the second apparatus, a message triggering the CSI report; and means for determining the CSI report based on the configuration, where the CSI report occupies a first set of CPUs for a first time duration for channel measurement, and where the CSI report occupies a second set of CPUs for a second time duration for the inference, the first set of CPUs being different from the second set of CPUs, and the second time duration being different from the first time duration.

In a sixteenth aspect of the present disclosure, there is provided another second apparatus. The second apparatus comprises means for transmitting, to a first apparatus, a configuration of an aperiodic CSI report based on an inference of a machine learning functionality, the configuration comprising a set of resources for channel measurement; and means for transmitting, to the first apparatus, a message triggering the CSI report, where the CSI report occupies a first set of CPUs of the first apparatus for a first time duration for channel measurement, and where the CSI report occupies a second set of CPUs of the first apparatus for a second time duration for the inference, the first set of CPUs being different from the second set of CPUs, and the second time duration being different from the first time duration.

In a seventeenth aspect of the present disclosure, there is provided another first apparatus. The first apparatus comprises means for receiving, from a second apparatus, a configuration of a periodic or semi-persistent CSI report based on an inference of a machine learning functionality, the configuration comprising a set of resources for channel measurement and a CSI inference resource; and means for determining the CSI report based on the configuration, where the CSI report occupies a first set of CPUs for a first time duration for channel measurement, and where the CSI report occupies a second set of CPUs for a second time duration for the inference, the first set of CPUs being different from the second set of CPUs, and the second time duration being different from the first time duration.

In an eighteenth aspect of the present disclosure, there is provided another second apparatus. The second apparatus comprises means for transmitting, to a first apparatus, a configuration of a periodic or semi-persistent CSI report based on an inference of a machine learning functionality, the configuration comprising a set of resources for channel measurement and a CSI reference resource; and means for transmitting, to the first apparatus, a configuration of at least one target occasion of at least one resource for channel measurement, where at least one of a first time duration or a second time duration is based on the configuration of the at least one target occasion, where the CSI report occupies a first set of CPUs of the first apparatus for the first time duration for channel measurement, and where the CSI report occupies a second set of CPUs of the first apparatus for the second time duration for the inference.

In a nineteenth aspect of the present disclosure, there is provided a computer readable medium. The computer readable medium comprises instructions stored thereon for causing an apparatus to perform at least the method according to the seventh aspect, the eighth aspect, the ninth aspect, the tenth aspect, the eleventh aspect, or the twelfth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2A to FIG. 2C illustrate example diagrams of AI/ML based BM with CSI framework, respectively;

FIG. 3 illustrates an example signaling flow for CPU time duration for inference in accordance with some example embodiments of the present disclosure;

FIG. 4 illustrates an example signaling flow for CPU time durations for measurement and inference for aperiodic CSI (AP-CSI) reporting in accordance with some example embodiments of the present disclosure;

FIG. 5 illustrates an example diagram of CPU occupation for BM with AP-CSI reporting in accordance with some example embodiments of the present disclosure;

FIG. 6 illustrates an example signaling flow for CPU time durations for measurement and inference for periodic CSI (P-CSI) or semi-persistent CSI (SP-CSI) reporting in accordance with some example embodiments of the present disclosure;

FIG. 7 illustrates an example diagram of CPU occupation for BM with P-CSI or SP-CSI reporting in accordance with some example embodiments of the present disclosure;

FIG. 8 illustrates a flowchart of a method implemented at a first apparatus in accordance with some example embodiments of the present disclosure;

FIG. 9 illustrates a flowchart of a method implemented at a second apparatus in accordance with some example embodiments of the present disclosure;

FIG. 10 illustrates another flowchart of a method implemented at a first apparatus in accordance with some example embodiments of the present disclosure;

FIG. 11 illustrates another flowchart of a method implemented at a second apparatus in accordance with some example embodiments of the present disclosure;

FIG. 12 illustrates another flowchart of a method implemented at a first apparatus in accordance with some example embodiments of the present disclosure;

FIG. 13 illustrates another flowchart of a method implemented at a second apparatus in accordance with some example embodiments of the present disclosure; and

FIG. 14 illustrates a simplified block diagram of a device that is suitable for implementing example embodiments of the present disclosure; and

FIG. 15 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “model” is referred to as an association between an input and an output learned from training data, and thus a corresponding output may be generated for a given input after the training. Specifically, the AI/ML model may refer to a data driven algorithm that applies AI/ML techniques to generate a set of outputs based on a set of inputs. The generation of the model may be based on a ML technique. The ML techniques may also be referred to as AI techniques. In general, a ML model can be built, which receives input information and makes predictions based on the input information. As used herein, a model is equivalent to an AI/ML model, or a data-driven/data processing algorithm/procedure.

As used herein, the term “AI/ML model delivery” is referred to as a generic term referring to delivery of an AI/ML model from one entity to another entity in any manner. It is to be noted that an entity may mean a network node/function (e.g., gNB, location management function (LMF), etc.), UE, proprietary server, etc. The term “AI/ML model Inference” is referred to as a process of using a trained AI/ML model to produce a set of outputs based on a set of inputs.

The term “AI/ML model testing” is referred to as a subprocess of training, to evaluate the performance of a final AI/ML model using a dataset different from one used for model training and validation. Differently from AI/ML model validation, testing does not assume subsequent tuning of the model.

The term “AI/ML model training” is referred to as a process to train an AI/ML Model, for example by learning the input/output relationship, in a data driven manner and obtain the trained AI/ML Model for inference.

The term “AI/ML model transfer” is referred to as a delivery of an AI/ML model over the air interface in a manner that is not transparent to 3GPP signalling, either parameters of a model structure known at the receiving end or a new model with parameters. Delivery may contain a full model or a partial model.

The term “AI/ML model validation” is referred to as a subprocess of training, to evaluate the quality of an AI/ML model using a dataset different from one used for model training, that helps selecting model parameters that generalize beyond the dataset used for model training.

The term “Data collection” is referred to as a process of collecting data by the network nodes, management entity, or UE for the purpose of AI/ML model training, data analytics and inference.

The term “federated learning/federated training” is referred to as a machine learning technique that trains an AI/ML model across multiple decentralized edge nodes (e.g., UEs, gNBs) each performing local model training using local data samples. The technique requires multiple interactions of the model, but no exchange of local data samples.

The term “Functionality identification” is referred to as a process/method of identifying an AI/ML functionality for the common understanding between the NW and the UE. It is to be noted that information regarding the AI/ML functionality may be shared during functionality identification. Where AI/ML functionality resides depends on the specific use cases and sub use cases.

The term “Model activation” is referred to as enabling an AI/ML model for a specific function. The term “Model deactivation” is referred to as disabling an AI/ML model for a specific function. The term “Model download” is referred to as a model transfer from the network to UE.

The term “Model identification” is referred to as a process or method of identifying an AI/ML model for the common understanding between the NW and the UE. It is to be noted that the process or method of model identification may or may not be applicable. It is to be noted that information regarding the AI/ML model may be shared during model identification.

The term “Model monitoring” is referred to as a procedure that monitors the inference performance of the AI/ML model. The term “Model parameter update” is referred to as a process of updating the model parameters of a model.

The term “Model selection” is referred to as a process of selecting an AI/ML model for activation among multiple models for the same AI/ML enabled feature. It is to be noted that model selection may or may not be carried out simultaneously with model activation.

The term “Model switching” is referred to as deactivating a currently active AI/ML model and activating a different AI/ML model for a specific function. The term “Model update” is referred to as a process of updating the model parameters and/or model structure of a model. The term “Model upload” is referred to as a model transfer from UE to the network.

The term “Network-side (AI/ML) model” is referred to as an AI/ML Model whose inference is performed entirely at the network. The term “UE-side (AI/ML) model” is referred to as an AI/ML Model whose inference is performed entirely at the UE. The term “Two-sided (AI/ML) model” is referred to as a paired AI/ML Model(s) over which joint inference is performed, where joint inference comprises AI/ML Inference whose inference is performed jointly across the UE and the network, i.e., the first part of inference is firstly performed by UE and then the remaining part is performed by gNB, or vice versa.

The term “Offline field data” is referred to as the data collected from field and used for offline training of the AI/ML model. The term “Online field data” is referred to as the data collected from field and used for online training of the AI/ML model.

The term “Offline training” is referred to as an AI/ML training process where the model is trained based on collected dataset, and where the trained model is later used or delivered for inference. It is to be noted that this definition only serves as a guidance. There may be cases that may not exactly conform to this definition but could still be categorized as offline training by commonly accepted conventions.

The term “Online training” is referred to as an AI/ML training process where the model being used for inference) is (typically continuously) trained in (near) real-time with the arrival of new training samples. Note: the notion of (near) real-time vs. non-real-time is context-dependent and is relative to the inference time-scale. It is to be noted that this definition only serves as a guidance. There may be cases that may not exactly conform to this definition but could still be categorized as online training by commonly accepted conventions. It is to be noted that fine-tuning/re-training may be done via online or offline training. This note may be removed for fine-tuning.

The term “Reinforcement Learning (RL)” is referred to as a process of training an AI/ML model from input (a.k.a. state) and a feedback signal (a.k.a. reward) resulting from the model's output (a.k.a. action) in an environment the model is interacting with. The term “semi-supervised learning” is referred to as a process of training a model with a mix of labelled data and unlabelled data. The term “supervised learning” is referred to as a process of training a model from input and its corresponding labels. The term “Unsupervised learning: A process of training a model without labelled data.

The term “proprietary-format models” is referred to as ML models of vendor-specific or device-specific proprietary format, from 3GPP perspective. They are not mutually recognizable across vendors and hide model design information from other vendors when shared. It is to be noted that an example is a device-specific binary executable format. The term “Open-format models” is referred to as ML models of specified format that are mutually recognizable across vendors and allow interoperability, from 3GPP perspective. They are mutually recognizable between vendors and do not hide model design information from other vendors when shared.

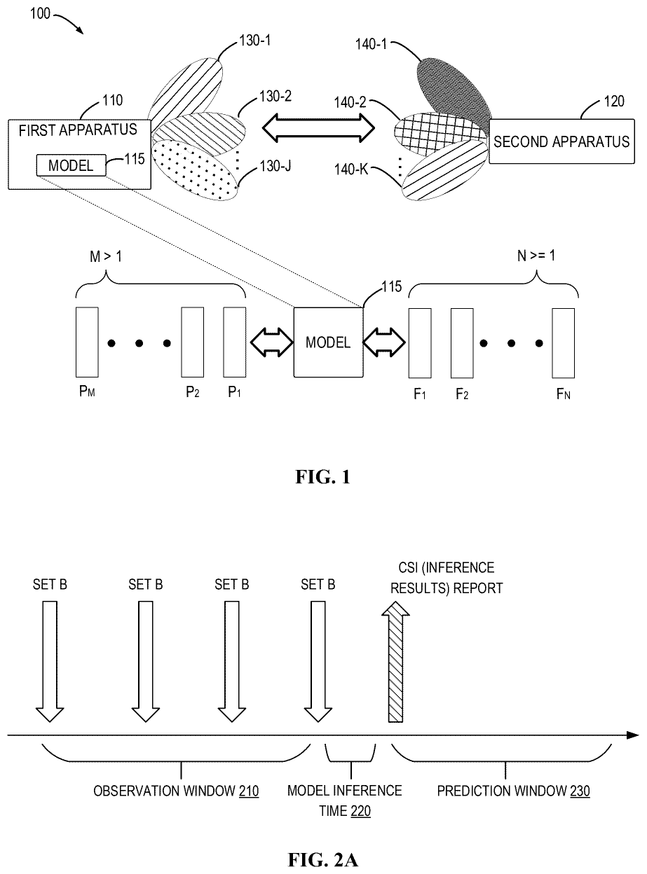

FIG. 1 shows an example communication environment 100 in which example embodiments of the present disclosure can be implemented. In the communication environment 100, a plurality of apparatuses including a first apparatus 110 and a second apparatus 120 communicate with each other.

In some example embodiments, if the first apparatus 110 is a terminal device and the second apparatus 120 is a network device serving the terminal device, a transmission direction from the second apparatus 120 to the first apparatus 110 is referred to as a downlink (DL), while a transmission direction from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver).

In some example embodiments, multiple input multiple output (MIMO) is supported in the communication environment 100. For example, the second apparatus 120 and the first apparatus 110 may communicate with each other via different beams to enable a directional communication. The first apparatus 110 may be configured with at least one beam (corresponding to at least one reference signal (RS)) used as reference for receiving/transmitting data and control channels. For example, the first apparatus 110 may have one or more physical downlink control channel (PDCCH) channels and one or more physical downlink shared channel (PDSCH) channels. The one or more PSCCH channels and/or one or more PDSCH channels may be configured to be received on one or more DL beams. UE may be capable of beamforming (i.e., it may be capable of forming UL/DL beams for TX and RX) or it may use omnidirectional transmission and reception.

As illustrated in FIG. 1, the second apparatus 120 transmits downlink transmission to the first apparatus 110 via one or more of beams 140-1, 140-2, . . . , and 140-K (K being an integer greater than or equal to 1). For purpose of discussion, the beams 140-1, 140-2, . . . , and 140-K are collectively or individually referred to as beam(s) 140.

Correspondingly, in uplink, the first apparatus 110 may transmit uplink transmission to the second apparatus 120 via one or more beams. As illustrated in FIG. 1, the first apparatus 110 transmits uplink transmission to the second apparatus 120 via the beams 130-1, 130-2, . . . , and 130-J (J being an integer greater than or equal to 1). For purpose of discussion, the beams 130-1, 130-2, . . . , and 130-J are collectively or individually referred to as beam(s) 130.

In the example of FIG. 1, the second apparatus 120 has a certain coverage range, which may be called as a serving area or a cell (not shown). The first apparatuses 110 are located in the cell covered by the second apparatus 120. In the communication environment 100, the second apparatus 120 may communicate data and control information to the first apparatus 110 and the first apparatus 110 may also communication data and control information to the second apparatus 120.

The coverage area or the cell may be covered by one or more beams provided by one or more Transmission or Reception Points (TRPs), for example, TRP #1, . . . . TRP #X. Each beam may carry an identifier enabling the first apparatus 110 to identify a beam and perform measurements (e.g., received power, reference signal received power (RSRP)) and other relevant measurements associate with specific identifier. Each synchronization signal block (SSB) may be identified based on the identifier carried by SSB block. Furthermore, for downlink measurement signals for beam management SSB beam may be further used to train.

In some example embodiments, a model functionality such as an AI/ML based functionality may be provided for the first apparatus 110 and/or the second apparatus 120. For example, the second apparatus 120 may provide a plurality of beams for the first apparatuses 110. The model functionality may be an AI/ML based beam management which predicts a beam such as a DL Tx beam for the first apparatus 110. In another example, the model functionality may be an AI/ML based beam management which predicts a DL Tx Rx beam pair for the first apparatus 110. For purpose of illustration, some example embodiments hereinafter will be described with the beam management or beam prediction as the model functionality.

The AI/ML based beam management may be spatial and/or time domain beam prediction. The spatial beam prediction (also referred to as BM-Case1) is to predict one or more best Tx beams or Tx-Rx beam pairs or corresponding reference signal received power (RSRP) values in different spatial locations. The time-domain beam predictions (also referred to as BM-Case2) aim to predict the best Tx beams or Tx-Rx beam pairs to use for next time instants. e.g., beam prediction in the spatial domain (BM-Case1) for next time instants. For purpose of illustration, some example embodiments are described where the model functionality is the spatial and/or time domain beam prediction.

In some example embodiments, one or more models may derive an outcome such as the predicted beam of the beam management. The one or more models may be implemented at the first apparatus 110 (shown as a model 115), or the second apparatus 120 (not shown), or both (not shown). The first apparatus 110 and/or the second apparatus 120 may perform the beam management by running inference or perform training. For purpose of illustration, some example embodiments hereinafter will be described with the model 115 implemented at the first apparatus 110.

In the example of FIG. 1, by using the model 115, the first apparatus 110 may use beam measurement results of M historical time instances to predict future beam(s) of N future time instances, where M is larger than one and N is larger than or equal to one. The beam measurement results of M historical time instances refer to measurement results of M latest measurement instances (represented as, P₁, P₂, . . . , P_{M} in the following text), which are used as input of the model 115. The output of the model is N predictions for N future time instances (represented as, F₁, F₂, . . . , F_{N} in the following text), where each prediction corresponds to one future time instance and may comprise one or more predicted beams.

It is to be understood that the number of apparatuses and their connections shown in FIG. 1 are only for the purpose of illustration without suggesting any limitation. The communication environment 100 may include any suitable number of apparatuses configured to implementing example embodiments of the present disclosure.

In the following, for purpose of illustration, some example embodiments are described with the first apparatus 110 operating as a terminal device and the second apparatus 120 operating as a network device. However, in some example embodiments, operations described in connection with a terminal device may be implemented at a network device or other device, and operations described in connection with a network device may be implemented at a terminal device or other device.

Communications in the communication environment 100 may be implemented according to any proper communication protocol(s), comprising, but not limited to, cellular communication protocols, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In some mechanisms, AI/ML general framework for one-sided AI/ML models within the realm of what has been studied. Signalling and protocol aspects of Life Cycle Management (LCM) enabling functionality and model (if justified) selection, activation, deactivation, switching, fallback have been studied. For example, identification related signalling is part of the above objective. Necessary signalling/mechanism(s) for LCM to facilitate model training, inference, performance monitoring, data collection (except for the purpose of core network (CN) or operation administration and maintenance (OAM) or over-the-top (OTT) collection of UE-sided model training data) for both UE-sided and network (NW)-sided models have been studies. Signalling mechanism of applicable functionalities/models has been studied.

Beam management such as DL Tx beam prediction for both UE-sided model and NW-sided model has been proposed, including spatial-domain DL Tx beam prediction for Set A of beams based on measurement results of Set B of beams (referred to as “BM-Case1”), temporal DL Tx beam prediction for Set A of beams based on the historic measurement results of Set B of beams (referred to as “BM-Case2”).

Necessary signalling/mechanism(s) to facilitate LCM operations specific to the Beam Management use cases have been studies, to enable method(s) to ensure consistency between training and inference regarding NW-side additional conditions (if identified) for inference at UE.

Necessity and details of model Identification concept and procedure in the context of LCM include CN or OAM or OTT collection of UE-sided model training data. For the FS_NR_AIML_Air study use cases, the corresponding contents of UE data collection may be identified, for example, analysing the UE data collection mechanisms identified during the FS_NR_AIML_Air study along with the implications and limitations of each of the methods.

For model transfer/delivery, whether there is a need to consider standardised solutions for transferring/delivering AI/ML model(s) considering at least the solutions identified during the FS_NR_AIML_Air study may be determined. It is noted that offline training is assumed for the purpose of this project, and the outcome of the study objectives should be captured for future reference. Coordination with service and system aspect (SA) or SA work groups (WGs) of the ongoing study or work as it may relate to their required work.

The LCM procedure is studied for the case that an AI/ML model has a model identifier (ID) with associated information and/or for the case that a given functionality is provided by some AI/ML operations. Applicability of functionality-based LCM and model-ID-based LCM is a separate discussion. As used herein, terms “ID”, “identifier”, “identity”, “index” or “indication” may be used interchangeably.

From random access network 1 (RAN1) perspective, an AI/ML model identified by a model ID may be logical, and how it maps to physical AI/ML model(s) may be up to implementation. When distinction is necessary for discussion purposes, the term “logical AI/ML model” may be used to refer to a model that is identified and assigned a model ID, and the term “physical AI/ML model(s)” may be used to refer to an actual implementation of such a model.

For UE-side models and UE-part of two-sided models, the followings have been discussed:
For AI/ML functionality identification, legacy 3GPP framework of feature is taken as a starting point. UE indicates supported functionalities/functionality for a given sub-use-case. Alternatively, UE capability reporting is taken as starting point.
For AI/ML model identification, models are identified by model ID at the Network. UE indicates supported AI/ML models.

In functionality-based LCM, network indicates activation or deactivation or fallback or switching of AI/ML functionality via 3GPP signalling (e.g., radio resource control (RRC), medium access control-control element (MAC-CE), downlink control information (DCI)). Models may not be identified at the Network, and UE may perform model-level LCM. Whether and how much awareness/interaction NW should have about model-level LCM requires further study. For functionality identification, there may be either one or more than one Functionalities defined within an AI/ML-enabled feature, whereby AI/ML-enabled Feature refers to a Feature where AI/ML may be used. UE may have one AI/ML model for the functionality, or UE may have multiple AI/ML models for the functionality.

For AI/ML functionality identification and functionality-based LCM of UE-side models and/or UE-part of two-sided models, functionality refers to an AI/ML-enabled Feature/FG enabled by configuration(s), where configuration(s) is (are) supported based on conditions indicated by UE capability. Correspondingly, functionality-based LCM operates based on, at least, one configuration of AI/ML-enabled Feature/FG or specific configurations of an AI/ML-enabled Feature/FG.

After functionality identification, necessity, mechanisms, for UE to report updates on applicable functionality(es) among functionality(es) are studied, where the applicable functionalities may be a subset of all functionalities. Applicable functionalities may be reported by the UE.

In model-ID-based LCM, models are identified at the Network, and Network/UE may activate or deactivate or select or switch individual AI/ML models via model ID. For AI/ML model identification and model-ID-based LCM of UE-side models and/or UE-part of two-sided models, model-ID-based LCM operates based on identified models, where a model may be associated with specific configurations/conditions associated with UE capability of an AI/ML-enabled Feature/FG and additional conditions (e.g., scenarios, sites, and datasets) as determined/identified between UE-side and NW-side.

After model identification, necessity, mechanisms, for UE to report updates on applicable UE part/UE-side model(s), are studied, where the applicable models may be a subset of all identified models. Applicable models may be reported by the UE.

How to handle the impact of UE's internal conditions such as memory, battery, and other hardware limitations on functionality/model operations and AI/ML-enabled Feature is to be studied. It does not preclude any existing solutions.

For functionality/model-ID based LCM, once functionalities/models are identified, the same or similar procedures may be used for their activation, deactivation, switching, fallback, and monitoring. Model ID, if needed, may be used in a Functionality (defined in functionality-based LCM) for LCM operations.

For AI/ML model identification of UE-side or UE-part of two-sided models, model identification is categorized in the following types:
Type A: Model is identified to NW (if applicable) and UE (if applicable) without over-the-air signalling. The model may be assigned with a model ID during the model identification, which may be referred/used in over-the-air signalling after model identification.
Type B: Model is identified via over-the-air signalling,
Type B1: Model identification initiated by the UE, and NW assists the remaining steps (if any) of the model identification. The model may be assigned with a model ID during the model identification.
Type B2: Model identification initiated by the NW, and UE responds (if applicable) for the remaining steps (if any) of the model identification. The model may be assigned with a model ID during the model identification.
   It is to be understood that it does not imply that model identification is necessary.

One example use case for Type B1 and B2 is model identification in model transfer from NW to UE. Another example is model identification with data collection related configuration(s) and/or indication(s) and/or dataset transfer. Other example use cases are not precluded. Offline model identification may be applicable for some of the example use cases.

Once models are identified, at least for Type A, UE may indicate supported AI/ML model IDs for a given AI/ML-enabled Feature/FG in a UE capability report as starting point. Note: model identification using capability report is not precluded for type B1 and type B2. Model ID may or may not be globally unique, and different types of model IDs may be created for a single model for various LCM purposes. Details may be studied in the WI phase.

For AI/ML enhancements related to beam management, two sub-use cases have been identified in RAN1: beam prediction in the spatial domain (BM-Case1) and beam prediction in the time domain (BM-Case2). The primary motivation is to support a reduced overhead and lower beam measurements and reporting latency. In the past RAN1 meetings, there were many agreements related to the AI/ML for BM and a few related agreements for the IR are copied below.

For AI/ML-based beam management, BM-Case1 and BM-Case2 are supported for characterization and baseline performance evaluations. BM-Case1 refers to spatial-domain DL beam prediction for Set A of beams based on measurement results of Set B of beams. BM-Case2 refers to temporal DL beam prediction for Set A of beams based on the historic measurement results of Set B of beams.

For the sub use case BM-Case1 and BM-Case2, further study the following alternatives for the predicted beams: Alt. 1: DL Tx beam prediction, Alt.2: DL Rx beam prediction, and Alt.3: Beam pair prediction (a beam pair consists of a DL Tx beam and a corresponding DL Rx beam). DL Rx beam prediction may or may not have spec impact.

In order to facilitate the AI/ML model inference, the following aspects may be studied as a starting point: enhanced or new configurations/UE reporting/UE measurement, e.g., Enhanced or new beam measurement and/or beam reporting, enhanced or new signaling for measurement configuration/triggering, signaling of assistance information (if applicable). Other aspect(s) is not precluded.

For BM-Case2 with a UE-side AI/ML model, the potential specification impact of L1 signaling to report the following information of AI/ML model inference to NW may be studied. For example, the beam(s) of N future time instance(s) that is based on the output of AI/ML model inference, and information about the timestamp corresponding the reported beam(s) may be discussed.

For BM-Case1 and BM-Case2 with a network-side AI/ML model, potential specification impact on the following L1 reporting enhancement for AI/ML model inference may be studied, including UE to report the measurement results of more than 4 beams in one reporting instance. Other L1 reporting enhancements may be considered.

For BM-Case2, necessity, benefit(s) and potential specification impact from the following additional aspects for AI model inference may be studied, including reporting information about measurements of multiple past time instances in one reporting instance for BM-Case2. It may be only applicable to network-side AI/ML model. The potential performance gains of measurement reporting should be justified by considering uplink control information (UCI) payload overhead.

For BM-Case1 and BM-Case2, necessity, benefit(s) and potential specification impact from the following additional aspects for AI model inference may be studied: how to perform beam indication of beams in Set A not in Set B. The legacy mechanism may be sufficient.

For BM-Case1 and BM-Case2 with a UE-side AI/ML model, potential specification impact of AI model inference from the following additional aspects on top of previous agreements may be studied: indication of the associated Set A from network to UE, e.g., association/mapping of beams within Set A and beams within Set B if applicable; and beam indication from network for UE reception. The beam indication may or may not have additional specification impact (e.g., legacy mechanism may be reused).

It is observed that at least for BM-Case1 with a UE-side AI/ML model, for AI model inference, the legacy TCI state mechanism may be used to perform beam indication of beams.

For UE-side model, existing CPU mechanism is used as a starting point for AI/ML-based CSI processing. For BM-Case 1, the UE-side AI/ML model uses measurements from a single time instance and may determine inference results immediately afterward to report predictions. Utilizing the existing CPU mechanism appears straightforward, as the inference is determined right after the measurements, and CPU usage can be accounted similarly to current CSI processing.

For BM-Case 2, the UE-side AI/ML model relies on measurements from multiple time instances, with inference results determined only after collecting the entire observation window's history of measurements. Different methods may be needed to account for AI/ML processing occupation. For example, the occupation may be considered for the entire observation window or just the latest time instance within it. Given that the observation window may span hundreds of milliseconds, it may not be practical to account for AI/ML processing over the entire window, necessitating further solutions to clarify this aspect.

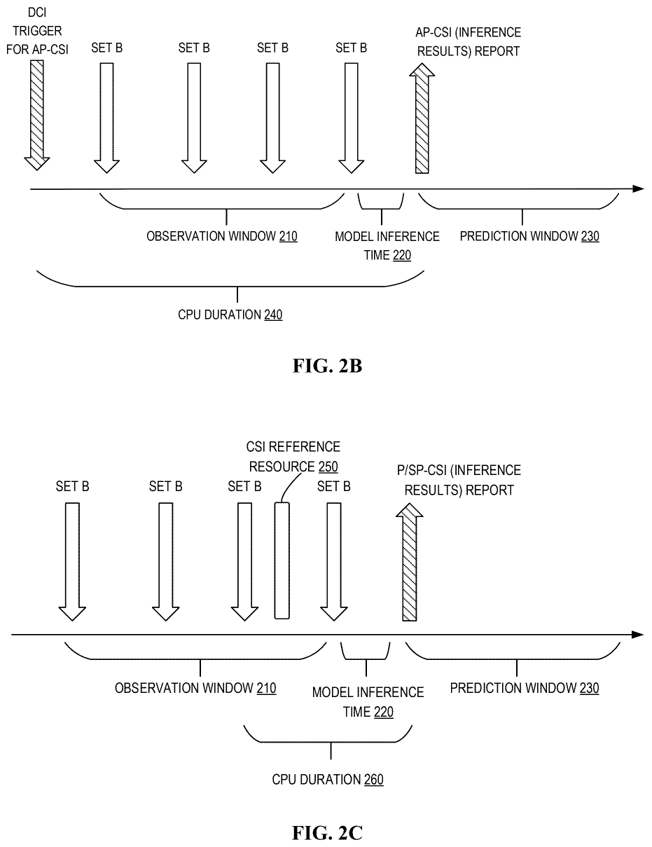

For inference operation of BM-Case2, the UE may measure Set B for more than one instance, to use as historical measurements at the model input, and each measurement instance of Set B refer to measuring multiple beams (i.e., multiple channel state information reference signal (CSI-RS) or synchronization signal block (SSB) resources). FIG. 2A illustrates an example diagram of AI/ML based BM with CSI framework. As shown, the UE may at least get the layer one reference signal received power (L1-RSRP) measurements for Set B over such an observation time 210 and use them at the model input to predict best beam (e.g., Top-1 or Top-K, K being a positive integer) in a different Set or larger Set of beams, i.e., Set A. For example, the L1-RSRP measurements for Set B in the observation time 210 may be used in a model inference time 220 to obtain the predicted Top-1 or Top-K best beam in a prediction window 230. The CSI report (for example, inference results report) may be Top-1 or Top-K beams of Set A for the prediction window 230, such as for N time instances in future, N being a positive integer.

As BM-Case2 maybe enabled with the CSI framework, there are several aspects that shall be clarified to reuse the legacy CSI framework with regard to the CPUs. CPU usage details are defined in the spec by considering many aspects such as hardware limitations at the UE, selection or prioritization of CSI reports for actual reporting, timelines of usage of CPUs per each CSI report, and other consideration to ensure common understanding between the NW and UE on CSI reporting behaviours.

Based on legacy framework, a UE may assume a number of CPUs (e.g., O_{CPU}) to be occupied for a CSI report for certain time durations, where time durations are clarified in the spec. For example, an aperiodic CSI report occupies CPU(s) from the first symbol after the physical downlink control channel (PDCCH) triggering the CSI report until the last symbol of the scheduled physical uplink shared channel (PUSCH) carrying the report. A periodic or semi-persistent CSI report occupies CPU(s) from the first symbol of the earliest one of each CSI-RS/SSB resource, respective latest CSI-RS/SSB occasion no later than the corresponding CSI reference resource, until the last symbol of the configured PUSCH or physical uplink control channel (PUCCH) carrying the report.

FIG. 2B illustrates an example diagram of AI/ML based BM-Case2 with the aperiodic CSI (AP-CSI) report when considering AP-CSI-RS resources. Assuming legacy behaviour for AP-CSI reporting is applied for BM-Case2 as it is, as shown in FIG. 2B, the CPU occupied duration (referred to as CPU duration 240) for BM-Case2 will be very large (e.g., more than 100 ms) and that may impact all other CSI reporting (as there is a total CPUs, N_{CPU}, limit that shared by all simultaneous CSI reports). The AP-CSI (inference results) report may be Top-1 or Top-K beams of Set A for the prediction window 230 (e.g., for N time instances in future).

FIG. 2C illustrates an example diagram of AI/ML based BM-Case2 with the periodic CSI (P-CSI) or semi-persistent CSI (SP-CSI) report when considering P-CSI or SP-SCI resources. Assuming legacy behaviour for SP/P-CSI reporting is applied for BM-Case2 as it is, as shown in FIG. 2C, the CPU occupied duration (that is, the CPU duration 260) for BM-Case2 may start from the latest Set B measurement instance prior to the CSI reference resource 250. Such CPU duration 260 will not fully reflect actual hardware usage of the UE (e.g., first 2 measurements are not counted for CPU calculation). Due to this, the UE may not measure certain Set B instances (e.g., first and second Set B measurement instances) and that will impact the inference performance.

In order to solve at least part of the above problems or other potential problems, several solutions on CPU duration time are proposed. In a solution, a second apparatus such as a network device transmits a configuration of CSI report based on model inference to a first apparatus such as a terminal device. The configuration includes a set of resources for channel measurements. The first apparatus determines the CSI report based on the configuration. The CSI report occupies a set of CPUs for a time duration for the inference. The time duration for the inference may be (pre) defined or configured. With such time duration for model inference, the inference performance may be improved.

In another solution, a second apparatus such as a network device configures a first apparatus such as a terminal device about an AP-CSI report based on a model inference. For example, a set of resources for channel measurements are configured. The second apparatus transmits a message triggering the CSI report to the first apparatus. The first apparatus determines the CSI report based on the configuration. The CSI report occupies a first set of CPUs for a first time duration for channel measurement. The CSI report occupies a second set of CPUs for a second time duration for the inference. The first set of CPUs are different from the second set of CPUs. The second time duration is different from the first time duration. By using different set of CPUs and different time durations for channel measurement and for model inference, CPU allocation may be improved.

In a further solution, a second apparatus such as a network device configures a first apparatus such as a terminal device about a P-CSI or SP-CSI report based on a model inference. For example, a set of resources for channel measurements and a CSI inference resource are configured. The first apparatus determines the CSI report based on the configuration. The CSI report occupies a first set of CPUs for a first time duration for channel measurement. The CSI report occupies a second set of CPUs for a second time duration for the inference. The first set of CPUs are different from the second set of CPUs. The second time duration is different from the first time duration. By using different set of CPUs and different time durations for channel measurement and for model inference, CPU allocation may be improved.

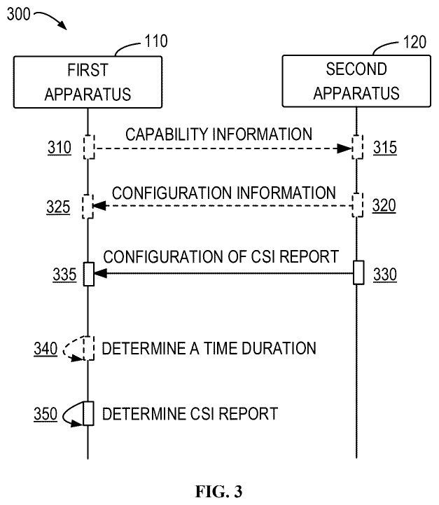

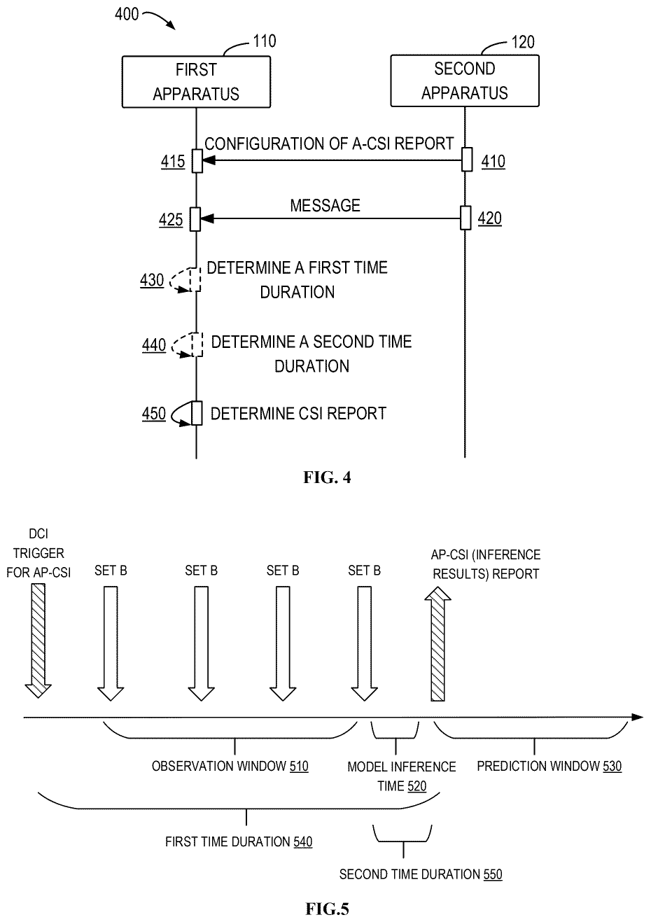

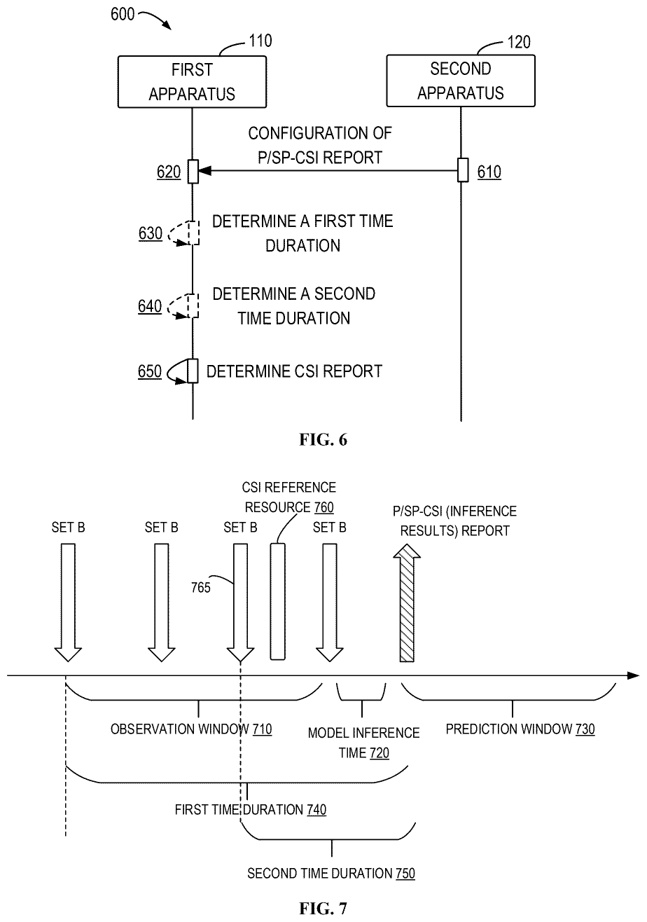

Several solutions for CPU time duration have been briefly described. Principle and implementations of the present disclosure will be described in detail below. It is noted the order acts shown in FIG. 3, FIG. 4, FIG. 6 and FIGS. 8-13 are only an example not limitation. Acts may be performed in any suitable manner. Example embodiments described with reference to FIG. 3, FIG. 4 and FIG. 6 may be implemented separately or combined in any manner. For example, one or more example embodiments shown in a single drawing may be combined with one or more example embodiments shown in one or more other drawings.

As briefly described, in a solution of the present disclosure, a CSI report based on model inference is configured. The CSI report occupies a set of CPUs for a time duration for model inference. FIG. 3 illustrates an example signalling flow 300 for CPU time duration for model inference in accordance with some example embodiments of the present disclosure. The signaling flow 300 involves the first apparatus 110 and the second apparatus 120 in FIG. 1.

In operation, the second apparatus 120 transmits (330), to the first apparatus 110, a configuration of a CSI report based on an inference of a machine learning functionality. Correspondingly, the first apparatus 110 receives (335), from the second apparatus 120, the configuration of CSI report. The configuration may indicate that the CSI report is based on the inference of the ML functionality. The ML functionality may be a functionality of a model at the first apparatus 110 and/or a model at the second apparatus 120. For example, the functionality may be BM Case2 or any other suitable functionality. The CSI report may be an aperiodic CSI report, a periodic CSI report, and/or a semi-persistent CSI report. The configuration comprises a set of resources for channel measurement. For example, the resources for channel measurement may include CSI-RS resources and/or SSB resources, and the like. The configuration of the CSI report may be a RRC configuration message or any other suitable message or signaling. In some embodiments, the set of resources for channel measurements for the BM-Case2 with CSI reporting may be referred to as a set of resources for prediction or a set of channel prediction resources.

The first apparatus 110 determines (350) the CSI report based on the configuration. The CSI report occupies a set of CPUs for a time duration for the inference. The set of CPUs may include one or more CPUs. As used herein, the set of CPUs for the inference may be referred to as a set of CPUs for inference or a set of inference CPUs. The set of CPUs for inference may refer to processing units dedicated for AI/ML functionality such as processing units dedicated for model inference. The time duration for the inference may be referred to as CPU time duration for inference or CPU duration for inference or inference CPU duration. The set of CPUs for inference and the time duration for inference may be (pre) defined or configured for the first apparatus 110. The first apparatus 110 may determine (340) the time duration for the inference.

In some embodiments, the first apparatus 110 may determine a starting time point of the time duration for the inference based on a latest resource or last symbol in a subset of the set of resources, an earliest resource or first symbol in a latest occasion of the set of resources, a latest resource or last symbol in the latest occasion of the set of resources, a symbol after a physical downlink control channel triggering the CSI report, and/or a latest resource or last symbol in a target occasion of a resource for channel measurement. For example, the subset of resources may refer to the resources in the set of resources that are no later than a corresponding CSI reference resource. The first apparatus 110 may determine that the subset of resources are no later than the corresponding CSI reference resource. The first apparatus 110 may determine that the latest occasion of the set of resources and/or the target occasion is no later than the corresponding CSI reference resource.

In some embodiments, the second apparatus 120 may transmit (320), to the first apparatus 110, configuration information of the time duration for the inference. The configuration information indicates the target occasion. The first apparatus 110 may receive (325) the configuration information. In some embodiments, the configuration information and the configuration of CSI report may be included in a single configuration message, or may be transmitted separately. With the configured target occasion, the first apparatus 110 may determine the starting time point of the time duration for inference. For example, the configuration information may indicate an index of the target occasion, such as M, M being a positive integer. The first apparatus 110 thus may select a latest resource or last symbol in the M-th latest occasion no later than the corresponding CSI reference resource.

Alternatively, or in addition, in some embodiments, the first apparatus 110 may transmit (310), to the second apparatus 120, capability information of the first apparatus 110. The second apparatus 120 receives (315) the capability information correspondingly. The capability information may indicate a target occasion of a resource for channel measurement. For example, the target occasion may be the M-th latest occasion no later than the corresponding CSI reference resource. A starting time point of the time duration for inference may be determined based on the target occasion, such as a latest resource or last symbol in the M-th latest occasion no later than the corresponding CSI reference resource. It is to be understood that the capability information may include other suitable capability of the first apparatus 110, embodiments of the present disclosure is not limited here. It is also to be understood that the target occasion may also be indicated in any other suitable message or signaling.

Alternatively, the first apparatus 110 may determine the target occasion based on an observation time window for the machine learning functionality. The machine learning functionality such as the BM-Case2 functionality collects channel measurement results during the observation time window. The first apparatus 110 may determine a latest resource or last symbol in the target occasion as the starting time of the time duration for inference.

Several embodiments regarding determining a starting time point for the time duration for inference have been described, the first apparatus 110 may further determine an ending time point for the time duration for inference. For example, the first apparatus 110 may determine the ending time point based on a scheduled PUSCH carrying the CSI report, and/or a scheduled PUCCH carrying the CSI report.

Several examples of the determined time duration for inference may be as follows:
a time duration from the last symbol of the latest one of each CSI-RS/SSB resource, respective latest CSI-RS/SSB occasion no later than the corresponding CSI reference resource, until the last symbol of the scheduled PUSCH carrying the report,
a time duration from the first symbol after the PDCCH triggering the CSI report, until the last symbol of the scheduled PUSCH carrying the report,
a time duration from the last symbol of P-th latest consecutive periodic/semi-persistent CSI-RS occasions no later than CSI reference resource, until the last symbol of the scheduled PUSCH carrying the report. P may be configured by the gNB, reported by the UE (via UE capability or other means), or determined with respect to the observation time window for BM-Case2,
a time duration from the last symbol of the latest one of each CSI-RS/SSB resource, respective latest CSI-RS/SSB occasion no later than the corresponding CSI reference resource, until the last symbol of the scheduled PUSCH/PUCCH carrying the report, or
a time duration from the last symbol of N-th latest consecutive periodic/semi-persistent CSI-RS occasions no later than CSI reference resource, until the last symbol of the scheduled PUSCH/PUCCH carrying the report. N may be configured by the gNB, reported by the UE (via UE capability or other means), or determined with respect to the observation time window for BM-Case2.

In some embodiments, the time duration for inference may include a first part for an activation of the machine learning functionality and a second part for the inference after the activation. A first number of CPUs may be occupied for the first part of the time duration, while a second number of CPUs may be occupied for the second part of the time duration. In such cases, the time duration for inference may start prior to the last symbol of the latest one of each CSI-RS/SSB resource, respective latest CSI-RS/SSB occasion no later than the corresponding CSI reference resource. For example, the second time duration may start from the first symbol after the PDCCH triggering the CSI report. Here, one or two values for the time duration for inference be assumed depending on whether timeline is for model activation or model inference.

The first apparatus 110 may determine a starting time point of the further time duration based on: a PDCCH triggering the CSI report, a further target occasion of a resource for channel measurement, the target occasion being no later than a corresponding CSI reference resource, and/or an earliest resource of the set of resources, an occasion of the earliest resource no later than the corresponding CSI reference resource. Similar to the target occasion for the time duration for inference, the further target occasion for the time duration for channel measurement may be configured by the second apparatus 120, or may be based on capability information of the first apparatus 110, or may be based on an observation time window for the machine learning functionality.

The first apparatus 110 may determine an ending time point of the further time duration based on a scheduled PUSCH carrying the CSI report, a latest resource in a subset of the set of resources, occasions of the subset of resources being no later than a corresponding CSI reference resource, and/or a latest occasion of the set of resources.

Several rules or parameters for determining the time duration for the channel measurements have been described. Several examples of the determined time duration for channel measurement based on these rules or parameters may be as follows:
a time duration from the first symbol after the PDCCH triggering the CSI report until the last symbol of the scheduled PUSCH carrying the report,
a time duration from the first symbol after the PDCCH triggering the CSI report until the last symbol of the latest one of each CSI-RS/SSB resource, respective latest CSI-RS/SSB occasion no later than the corresponding CSI reference resource,
a time duration from the first symbol of M-th latest consecutive periodic/semi-persistent CSI-RS occasions no later than CSI reference resource, until the last symbol of the scheduled PUSCH carrying the report, where M may be configured by the second apparatus 120, reported as the capability information of the first apparatus 110, or determined with respect to the observation time window for BM-Case2,
a time duration from the first symbol of M-th latest consecutive periodic/semi-persistent CSI-RS occasions no later than CSI reference resource, until the last symbol of the latest one of each CSI-RS/SSB resource, respective latest (1st latest) CSI-RS/SSB occasion no later than the corresponding CSI reference resource, M may be configured by the second apparatus 120, reported as the capability information of the first apparatus 110, or determined with respect to the observation time window for BM-Case2,
a time duration from the first symbol of the earliest one of each CSI-RS/SSB resource, respective latest CSI-RS/SSB occasion no later than the corresponding CSI reference resource, until the last symbol of the configured PUSCH/PUCCH carrying the report,
a time duration from the first symbol of M-th latest consecutive periodic/semi-persistent CSI-RS occasions no later than CSI reference resource, until the last symbol of the scheduled PUSCH/PUCCH carrying the report, M may be configured by the second apparatus 120, reported as the capability information of the first apparatus 110, or determined with respect to the observation time window for BM-Case2, or
a time duration from the first symbol of M-th latest consecutive periodic/semi-persistent CSI-RS occasions no later than CSI reference resource, until the last symbol of the latest one of each CSI-RS/SSB resource, respective latest (1st latest) CSI-RS/SSB occasion no later than the corresponding CSI reference resource, M may be configured by the second apparatus 120, reported as the capability information of the first apparatus 110, or determined with respect to the observation time window for BM-Case2.

Several examples of the time duration for inference and the time duration for channel measurement have been described. It is to be understood that these time durations are only for the purpose of illustration, without suggesting any limitation. For a UE that is configured with a CSI report configuration to support the functionality such as BM-Case2 inference operation at the UE-side, the CPU time duration for inference and the CPU time duration for the channel measurement for the BM-Case2 inference report such as the CSI report may be defined for aperiodic or periodic or semi-persistent CSI reporting. With these time durations, the CPUs occupation and allocation can be enhanced. In this manner, the hardware utilization for CPU calculation can be optimized. The performance for BA-Case2 with CSI reporting can be enhanced as well.

In some embodiments, the proposed CPU time duration may be applied in combination with any suitable CSI processing criteria. In some embodiments, the first apparatus 110 such as the UE may indicate the number of supported simultaneous CSI calculations N_{CPU} with parameter simultaneousCSI-ReportsPerCC in a component carrier, and simultaneousCSI-ReportsAIICC across all component carriers. If a UE supports N_{CPU} simultaneous CSI calculations, it is said to have N_{CPU} CSI processing units for processing CSI reports. If L CPUs are occupied for calculation of CSI reports in a given orthogonal frequence division multiplexing (OFDM) symbol, the UE has N_{CPU}−L unoccupied CPUs. If N CSI reports start occupying their respective CPUs on the same OFDM symbol on which N_{CPU}−L CPUs are unoccupied, where each CSI report n=0, . . . , N−1 corresponds to

$${O}_{CPU}^{( n )} ,$$

the UE is not required to update the N−M requested CSI reports with lowest priority, where 0≤M≤N is the largest value such that

$${\sum }_{n = 0}^{M - 1} {O}_{CPU}^{( n )} \leq {N}_{CPU} - L$$

holds.

A UE is not expected to be configured with an aperiodic CSI trigger state containing more than N_{CPU} reporting settings. Processing of a CSI report occupies a number of CPUs for a number of symbols as follows:
O_{CPU}=0 for a CSI report with CSI-ReportConfig with higher layer parameter reportQuantity set to ‘none’ and CSI-RS-ResourceSet with higher layer parameter trs-Info configured.
O_{CPU}=1 for a CSI report with CSI-ReportConfig with higher layer parameter reportQuantity set to ‘cri-RSRP’, ‘ssb-Index-RSRP’, ‘cri-SINR’, ‘ssb-Index-SINR’, ‘cri-RSRP-Index’, ‘ssb-Index-RSRP-Index’, ‘cri-SINR-Index’, ‘ssb-Index-SINR-Index’ or ‘none’ (and CSI-RS-ResourceSet with higher layer parameter trs-Info not configured).
O_{CPU}=(Y+1)· X, for a CSI report with CSI-ReportConfig with higher layer parameter reportQuantity set to ‘tdcp’ and with number of delays Y configured by higher layer parameter Y, where the value of X∈{1, 2} is reported by UE capability.
for a CSI report with CSI-ReportConfig with higher layer parameter reportQuantity set to ‘cri-RI-PMI-CQI’, ‘cri-RI-i1’, ‘cri-RI-i1-CQI’, ‘cri-RI-CQI’, or ‘cri-RI-LI-PMI-CQI’,
if max {μ_{PDCCH}, μ_{CSI-RS}, μ_{UL}}≤3, and if a CSI report is aperiodically triggered without transmitting a PUSCH with either transport block or HARQ-ACK or both when L=0 CPUs are occupied, where the CSI corresponds to a single CSI with wideband frequency-granularity and to at most 4 CSI-RS ports in a single resource without CRI report and where codebookType is set to ‘typeI-SinglePanel’ or where reportQuantity is set to ‘cri-RI-CQI’, O_{CPU}=N_{CPU},
if a CSI-ReportConfig is configured with codebookType set to ‘typeI-SinglePanel’ and the corresponding CSI-RS Resource Set for channel measurement is configured with two Resource Groups and N Resource Pairs, O_{CPU}=X·N+M, where X is the number of CPUs occupied by a pair of CMRs subject to m TRP-CSI-numCPU-r17 and M is defined in a standard,
if a CSI-ReportConfig contains a list of L sub-configurations provided by the higher layer parameter [csi-ReportSubConfigList],

$${O}_{CPU} = {\sum }_{i = 1}^{L} {K}_{s}^{i}$$

for periodic CSI reporting, where

$${K}_{s}^{i}$$

is the total number of CSI-RS resources corresponding to the i-th sub-configuration.

$${O}_{CPU} = {\sum }_{i = 1}^{N} {K}_{s}^{i}$$

for aperiodic and semi-persistent CSI reporting, where

$${K}_{s}^{i}$$

is the total number of CSI-RS resources corresponding to the i-th sub-configuration, and where the i-th sub-configuration is from N indicated sub-configurations out of L sub-configurations contained in a CSI-ReportConfig, where N≤L and N≥1.
if a CSI-ReportConfig is configured with the higher layer parameter reportQuantity set to ‘cri-RI-PMI-CQI’, codebookType set to ‘typeII-CJT-r18’ or ‘typeII-CJT-PortSelection-r18’ and the corresponding NZP-CSI-RS-ResourceSet for channel measurement is configured with 1<N_{TRP}≤4 resources, O_{CPU}=X·N_{TRP}, where X∈{1, 1.5, 2} is reported by UE capability indication,
if a CSI-ReportConfig is configured with the higher layer parameter reportQuantity set to ‘cri-RI-PMI-CQI’ and with codebookType set to ‘typeII-Doppler-r18’ or ‘typeII-Doppler-PortSelection-r18’,
if the corresponding CSI-RS Resource Set for channel measurement is aperiodic and configured with K CSI-RS resources, O_{CPU}=Y₁·K, where Y₁∈{⅔, 1, 2, 3} is reported by UE capability indication,
if the corresponding CSI-RS Resource Set for channel measurement is periodic or semi-persistent and configured with a single CSI-RS resource, O_{CPU}=4 for N₄=1 and O_{CPU}=Y₂·N₄≥4, for N₄>1, where the value of N₄ is configured by the higher layer parameter N₄, and Y₂ E {⅔, 1, 2, 3} is reported by UE capability indication,
otherwise, O_{CPU}=Kₛ, where Kₛ is the number of CSI-RS resources in the CSI-RS resource set for channel measurement.

For a CSI report with CSI-ReportConfig with higher layer parameter reportQuantity not set to ‘none’, the CPU(s) are occupied for a number of OFDM symbols as follows:
A periodic or semi-persistent CSI report (excluding an initial semi-persistent CSI report on PUSCH after the PDCCH triggering the report) occupies CPU(s) from the first symbol of the earliest one of each CSI-RS or CSI inference measurement (CSI-IM) or SSB resource for channel or interference measurement, respective latest CSI-RS or CSI-IM or SSB occasion no later than the corresponding CSI reference resource, until the last symbol of the configured PUSCH/PUCCH carrying the report.
An aperiodic CSI report occupies CPU(s) from the first symbol after the PDCCH triggering the CSI report until the last symbol of the scheduled PUSCH carrying the report. When the PDCCH reception includes two PDCCH candidates from two respective search space sets, as described in a standard such as clause 10.1 of [6, technical standard (TS) 38.213], for the purpose of determining the CPU occupation duration, the PDCCH candidate that ends later in time is used.
An initial semi-persistent CSI report on PUSCH after the PDCCH trigger occupies CPU(s) from the first symbol after the PDCCH until the last symbol of the scheduled PUSCH carrying the report. When the PDCCH reception includes two PDCCH candidates from two respective search space sets, as described in a standard such as clause 10.1 of [6, TS 38.213], for the purpose of determining the CPU occupation duration, the PDCCH candidate that ends later in time is used.

For a CSI report with CSI-ReportConfig with higher layer parameter reportQuantity set to ‘none’ and CSI-RS-ResourceSet with higher layer parameter trs-Info not configured, the CPU(s) are occupied for a number of OFDM symbols as follows:
A semi-persistent CSI report (excluding an initial semi-persistent CSI report on PUSCH after the PDCCH triggering the report) occupies CPU(s) from the first symbol of the earliest one of each transmission occasion of periodic or semi-persistent CSI-RS/SSB resource for channel measurement for L1-RSRP computation, until

$${Z}_{3}^{′}$$

symbols after the last symbol of the latest one of the CSI-RS/SSB resource for channel measurement for L1-RSRP computation in each transmission occasion.
An aperiodic CSI report occupies CPU(s) from the first symbol after the PDCCH triggering the CSI report until the last symbol between Z₃ symbols after the first symbol after the PDCCH triggering the CSI report and

$${Z}_{3}^{′}$$

symbols after the last symbol of the latest one of each CSI-RS/SSB resource for channel measurement for L1-RSRP computation.
where

$$( {Z}_{3} , {Z}_{3}^{′} )$$

are defined in a standard such as Table 1 below. It is to be understood that these values in Table 1 are only for the purpose of illustration, without suggesting any limitation.

TABLE 1
CSI computation delay requirement 1

Z₁ [symbols]

| μ | Z₁ | Z′₁ |
|---|---|---|
| 0 | 10 | 8 |
| 1 | 13 | 11 |
| 2 | 25 | 21 |
| 3 | 43 | 36 |

In some embodiments, Table 2 shows another CSI computation delay requirement. It is to be understood that these values in Table 2 are only for the purpose of illustration, without suggesting any limitation.

TABLE 2
CSI computation delay requirement 2

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, X₂ + KB₁) | X₂ |
| 3 | 97 | 85 | 152 | 140 | min(97, X₃ + KB₂) | X₃ |
| 5 | 388 | 340 | 608 | 560 | min(388, X5 + KB3) | X5 |
| 6 | 776 | 680 | 1216 | 1120 | min(776, X6 + KB4) | X6 |

In some embodiments, details of the CSI processing criteria and CSI computation time may be adjusted based on the CPU time duration for inference. Details of the updated CSI processing criteria and CSI computation time will be described with respect to FIG. 4 to FIG. 7 below.

As briefly described, in a solution of the present disclosure, a second apparatus such as a network device configures a first apparatus such as a terminal device about AP-CSI report based on a machine learning functionality. The second apparatus further transmits a message triggering the CSI report. The first apparatus thus determines the CSI report to be transmitted to the second apparatus. The CSI report occupies a first set of CPUs for a first time duration for channel measurement. The CSI report occupies a second set of CPUs for a second time duration for inference. In this manner, different sets of CPUs and different time durations are (pre) defined for the first apparatus for the channel measurement and for the inference. The hardware utilization and allocation can thus be improved.

FIG. 4 illustrates an example signaling flow 400 for CPU time durations for measurement and inference for aperiodic CSI (AP-CSI) reporting in accordance with some example embodiments of the present disclosure. The signaling flow 400 involves the first apparatus 110 and the second apparatus 120 in FIG. 1.

In operation, the second apparatus 120 transmits (410), to the first apparatus 110, a configuration of an aperiodic CSI report based on an inference of a machine learning functionality. The configuration includes a set of resources for channel measurement such as a set of channel prediction resources. The first apparatus 110 receives (415) the configuration from the second apparatus 120. By way of example, the configuration may be an RRC configuration message or any other suitable message or signaling. The set of resources may include CSI-RS resources and/or SSB resources, or the like.

The second apparatus 120 transmits (420), to the first apparatus 110, a message triggering the CSI report. Correspondingly, the first apparatus 110 receives (425) the message. By way of example, the message may include a PUCCH message triggering the AP-CSI report.

The first apparatus 110 determines (450) the CSI report based on the configuration. The CSI report may be then transmitted to the second apparatus 120.

The CSI report occupies a first set of CPUs of the first apparatus 110 for a first time duration for channel measurement. The first set of CPUs may referred to as a set of CPUs for channel measurement or channel measurement CPUs. The first time duration may be referred to as CPU (time) duration for channel measurement or channel measurement (time) duration. The first time duration may be defined for the first apparatus 110. In some embodiments, the first apparatus 110 may determine (430) the first time duration.

The CSI report occupies a second set of CPUs of the first apparatus 110 for a second time duration for the inference. The second set of CPUs may be referred to as a set of CPUs for inference or inference CPUs. The second time duration may be referred to as CPU (time) duration for inference or inference (time) duration. The first set of CPUs being different from the second set of CPUs. The second time duration being different from the first time duration. The second time duration may be defined for the first apparatus 110. In some embodiments, the first apparatus 110 may determine (440) the second time duration.

In an embodiment, a starting time point of the second time duration may be determined as a last symbol of a latest resource in a subset of the set of resources, or a latest resource or a last symbol of a latest occasion of the set of resources. In some embodiments, the first apparatus 110 may determine that the subset of resources are no later than a corresponding CSI reference resource. As used herein, the subset of resources may refer to those resources in the set of resources that are no later than the corresponding CSI reference resource.

In another embodiment, the starting time point of the second time duration may be an earliest resource or first symbol of the latest occasion of the set of resources. In some embodiments, the first apparatus 110 may determine that the latest occasion of the set of resources is no later than a corresponding CSI reference resource.

In a further embodiment, the starting time point of the second time duration may be a first symbol after the message triggering the CSI report. For example, the starting time point may be a first symbol after the PDCCH triggering the CSI report.

In a further embodiment, the starting time point of the second time duration may be a last symbol of a first target occasion of a resource for channel measurement. In some embodiments, the first apparatus 110 may determine that the first target occasion is no later than a corresponding CSI reference resource. By way of example, the first target occasion may be an M-th latest resource of the set of resources, M being a positive integer.

In some embodiments, the second apparatus 120 may transmit, to the first apparatus 110, a configuration of the first target occasion. For example, the configuration may include the index M. Alternatively, the first apparatus 110 may transmit, to the second apparatus 120, capability information of the first apparatus 110. The capability information may indicate the first target occasion, such as M. Alternatively, the first apparatus 110 may determine the first target occasion based on an observation time window. The machine learning functionality collects channel measurement results during the observation time window. That is, M may be determined based on a configuration of the first target occasion from the second network, a capability of the first apparatus 110, and/or the observation time window for the machine learning functionality.

In some embodiments, an ending time point of the second time duration comprises a last symbol of a scheduled channel carrying the CSI report, such as a PUSCH carrying the CSI report.

In some embodiments, the second time duration may include a first part for an activation of the machine learning functionality and a second part for the inference after the activation. A first number of CPUs may be occupied for the first part of the second time duration, while a second number of CPUs may be occupied for the second part of the second time duration.

In some embodiments, a starting time point of the first time duration may be a first symbol after the message such as PDCCH triggering the CSI report, or a first symbol of a second target occasion of a resource for channel measurement. For example, the second target occasion may be no later than a corresponding CSI reference resource. Similar to the first target occasion, the second target occasion or an index of the second target occasion may be determined based on a configuration from the second apparatus 120, capability information of the first apparatus 110, and/or the observation time window for the machine learning functionality.

In some embodiments, an ending time point of the first time duration may be a last symbol of a scheduled channel such as PUSCH carrying the CSI report, a last symbol of a latest resource in a subset of the set of resources, or a last symbol of a latest occasion of the set of resources. Occasions of the subset of resources are no later than a corresponding CSI reference resource.

Several rules or parameters for determining the first time duration and the second time duration have been described. FIG. 5 illustrates an example diagram of CPU occupation for BM with AP-CSI reporting in accordance with some example embodiments of the present disclosure. As shown, the first time duration 540 starts from a message triggering the AP-CSI such as DCI triggering the AP-CSI and ends at the scheduled PUSCH carrying the AP-CSI report. Specifically, the first time duration 540 is from the first symbol after the PDCCH triggering the CSI report until the last symbol of the scheduled PUSCH carrying the report. The first time duration 510 may cover an observation window 510 and a model inference time 520. The second time duration 550 starts from a last symbol of the latest one of each CSI-RS/SSB resource, respective latest CSI-RS/SSB occasion no later than the corresponding CSI reference resource, until the last symbol of the scheduled PUSCH carrying the report. The second time duration 550 may cover the model inference time 520. The AP-CSI report may be transmitted in a prediction window 530.

It is to be understood that these example embodiments of the determination and definition of the first and second time durations are only for the purpose of illustration, without suggesting any limitation. For example, the first time duration may be from a second symbol or any other suitable symbol after the PDCCH triggering the CSI report until a last symbol or a penultimate symbol of the scheduled PUSCH carrying the CSI report. These determinations and definitions of the first and second time durations may be adjusted in any suitable manner. Scope of the present disclosure is not limited here.

In some embodiments, if the BM-Case2 is enabled by an aperiodic CSI report, the CSI report occupies a first number of CPU(s) (referred to as O_{CPU,1}) for a first time duration. The first time duration may be from the first symbol after the PDCCH triggering the CSI report until the last symbol of the scheduled PUSCH carrying the report. Here, O_{CPU,1} value may be assumed to be smaller or same as O_{CPU} considered for L1-RSRP reporting, where the UE considers CPUs mainly for L1-RSRP measurements. As the use of smaller value for O_{CPU,1}, the delay associated with the BM-Case2 measurements may reflect actual lower hardware usage and avoid the impact on other CSI reports.

In one variant, the CSI report occupies the first number of CPU(s) (O_{CPU,1}) from the first symbol after the PDCCH triggering the CSI report until the last symbol of the latest one of each CSI-RS/SSB resource, respective latest CSI-RS/SSB occasion no later than the corresponding CSI reference resource.

In one variant, where the respective latest CSI-RS/SSB occasion no later than the corresponding CSI reference resource is not applicable for AP-CSI-RS based BM-Case2, the latest CSI-RS/SSB occasions is used as the start time.

In another variant, the CSI report occupies the first number of CPU(s) (O_{CPU,1}) from the first symbol of M^{th} latest consecutive periodic/semi-persistent CSI-RS occasions no later than CSI reference resource, until the last symbol of the scheduled PUSCH carrying the report. M may be configured by the gNB, reported as the UE capability, or determined with respect to the observation time window for BM-Case2.

In another variant, the CSI report occupies the first number of CPU(s) (O_{CPU,1}) from the first symbol of M^{th} latest consecutive periodic/semi-persistent CSI-RS occasions no later than CSI reference resource, until the last symbol of the latest one of each CSI-RS/SSB resource, respective latest (1st latest) CSI-RS/SSB occasion no later than the corresponding CSI reference resource. M may be configured by the gNB, reported by the UE (via UE capability report or other means), or determined with respect to the observation time window for BM-Case2.

The CSI report occupies a second number of CPU(s) (referred to as O_{CPU,2}) for a second time duration. The second time duration may be from the last symbol of the latest one of each CSI-RS/SSB resource, respective latest CSI-RS/SSB occasion no later than the corresponding CSI reference resource, until the last symbol of the scheduled PUSCH carrying the report. In one variant, where the respective latest CSI-RS/SSB occasion no later than the corresponding CSI reference resource is not applicable for AP-CSI-RS based BM-Case2, the latest CSI-RS/SSB occasions may be used as the start time. Here, O_{CPU,2} value may reflect CPU usage for ML model inference operation, where the measurements (L1-RSRPs) are used for the inference operation. The value of O_{CPU,2} can be larger than the CPU assumptions on L1-RSRP reporting. As a smaller delay is assumed for the second time duration, the impact on BM-Case2 inference operation may reflect actual higher hardware usage and avoid the impact on other CSI reports.

In one variant, the CSI report occupies the second number of CPU(s) (O_{CPU,2}) from the first symbol after the PDCCH triggering the CSI report, until the last symbol of the scheduled PUSCH carrying the report.

In one variant, the CSI report occupies the second number of CPU(s) (O_{CPU,2}) from the last symbol of P^{th} latest consecutive periodic/semi-persistent CSI-RS occasions no later than CSI reference resource, until the last symbol of the scheduled PUSCH carrying the report. P may be configured by the gNB, reported by the UE (via UE capability or other means), or determined with respect to the observation time window for BM-Case2.

In one variant, the second time duration may consist of more than one component, where one can be related to the model activation delay and an another can be related to the model inference after activation. In such cases, the second time duration may start prior to the last symbol of the latest one of each CSI-RS/SSB resource, respective latest CSI-RS/SSB occasion no later than the corresponding CSI reference resource. For example, the second time duration may start from the first symbol after the PDCCH triggering the CSI report. Here, one or two values for O_{CPU,2} may be assumed depending on whether timeline is for model activation or model inference.

In some embodiments, it is also possible that only second time duration is defined to the UE. In such cases, the first time duration may be not considered by the UE.

In some embodiments, the CSI processing criteria may be adjusted based on the first and second time durations. Specifically, the first apparatus 110 such as the UE may indicate the number of supported simultaneous CSI calculations N_{CPU} with parameter simultaneousCSI-ReportsPerCC in a component carrier, and simultaneousCSI-ReportsAIICC across all component carriers. If a UE supports N_{CPU} simultaneous CSI calculations it is said to have N_{CPU} CSI processing units for processing CSI reports. If L CPUs are occupied for calculation of CSI reports in a given OFDM symbol, the UE has N_{CPU}−L unoccupied CPUs. If N CSI reports start occupying their respective CPUs on the same OFDM symbol on which N_{CPU}−L CPUs are unoccupied, where each CSI report n=0, . . . , N−1 corresponds to

$${O}_{CPU}^{( n )} ,$$

the UE is not required to update the N−M requested CSI reports with lowest priority (according to Clause 5.2.5), where 0≤M≤N is the largest value such that

$${\sum }_{n = 0}^{M - 1} {O}_{CPU}^{( n )} \leq {N}_{CPU} - L$$

holds.

A UE is not expected to be configured with an aperiodic CSI trigger state containing more than N_{CPU} Reporting Settings. Processing of a CSI report occupies a number of CPUs for a number of symbols as follows:
O_{CPU}=0 for a CSI report with CSI-ReportConfig with higher layer parameter reportQuantity set to ‘none’ and CSI-RS-ResourceSet with higher layer parameter trs-Info configured; b
O_{CPU}=1 for a CSI report with CSI-ReportConfig with higher layer parameter reportQuantity set to ‘cri-RSRP’, ‘ssb-Index-RSRP’, ‘cri-SINR’, ‘ssb-Index-SINR’, ‘cri-RSRP-Index’, ‘ssb-Index-RSRP-Index’, ‘cri-SINR-Index’, ‘ssb-Index-SINR-Index’ or ‘none’ (and CSI-RS-ResourceSet with higher layer parameter trs-Info not configured);
O_{CPU}=1 and O_{CPU,ML}=X for a CSI report with CSI-ReportConfig that configured with more than one measurement instance for the channel measurement resource set and configured to report, with higher layer parameter reportQuantity set to ‘cri-RSRP-N’, ‘ssb-Index-RSRP-N’, ‘cri-N’, or ‘ssb-Index-N’, corresponding to channel prediction resources.

For a CSI report with CSI-ReportConfig with higher layer parameter reportQuantity not set to ‘none’, the CPU(s) are occupied for a number of OFDM symbols as follows:
A periodic or semi-persistent CSI report (excluding an initial semi-persistent CSI report on PUSCH after the PDCCH triggering the report) occupies CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the configured PUSCH/PUCCH carrying the report.
An aperiodic CSI report (excluding an aperiodic CSI report that carrying ‘cri-RSRP-N’, ‘ssb-Index-RSRP-N’, ‘cri-N’, or′ssb-Index-N′ corresponding to channel prediction resources) occupies CPU(s) from the first symbol after the PDCCH triggering the CSI report until the last symbol of the scheduled PUSCH carrying the report. When the PDCCH reception includes two PDCCH candidates from two respective search space sets, as described in clause 10.1 of [6, TS 38.213], for the purpose of determining the CPU occupation duration, the PDCCH candidate that ends later in time is used.
An aperiodic CSI that carrying ‘cri-RSRP-N’, ‘ssb-Index-RSRP-N’, ‘cri-N’, or ‘ssb-Index-N’ corresponding to channel prediction resources occupies first and second CPU(s), the first CPUs, given by O_{CPU}, occupies from the first symbol after the PDCCH triggering the CSI report until the last symbol of the scheduled PUSCH carrying the report and the second CPUs, given by O_{CPU,ML}, from the last symbol of the latest one of each CSI-RS/SSB resource, respective latest CSI-RS/SSB occasion no later than the corresponding CSI reference resource until the last symbol of the scheduled PUSCH carrying the report. When the PDCCH reception includes two PDCCH candidates from two respective search space sets, as described in clause 10.1 of [6, TS 38.213], for the purpose of determining the CPU occupation duration, the PDCCH candidate that ends later in time is used.
An initial semi-persistent CSI report on PUSCH after the PDCCH trigger occupies CPU(s) from the first symbol after the PDCCH until the last symbol of the scheduled PUSCH carrying the report. When the PDCCH reception includes two PDCCH candidates from two respective search space sets, as described in clause 10.1 of [6, TS 38.213], for the purpose of determining the CPU occupation duration, the PDCCH candidate that ends later in time is used.

Several embodiments for CPU time duration for inference for the AP-CSI reporting have been described. With these embodiments, the hardware utilization and allocation for CPU calculation can be optimized. The BM-Case2 with AP-CSI framework may be enhanced.

As briefly described, in a solution of the present disclosure, a second apparatus such as a network device configures a first apparatus such as a terminal device about P-CSI report or SP-CSI report based on a machine learning functionality. The first apparatus thus determines the CSI report to be transmitted to the second apparatus based on the configuration. The CSI report occupies a first set of CPUs for a first time duration for channel measurement. The CSI report occupies a second set of CPUs for a second time duration for inference. In this manner, different sets of CPUs and different time durations are (pre) defined for the first apparatus for the channel measurement and for the inference. The hardware utilization and allocation can thus be improved.

FIG. 6 illustrates an example signaling flow 600 for CPU time durations for measurement and inference for periodic CSI (P-CSI) or semi-persistent CSI (SP-CSI) reporting in accordance with some example embodiments of the present disclosure. The signaling flow 600 involves the first apparatus 110 and the second apparatus 120 in FIG. 1.

In operation, the second apparatus 120 transmits (610), to the first apparatus 110, a configuration of a periodic or semi-persistent CSI report based on an inference of a machine learning functionality. The configuration includes a set of resources for channel measurement such as CSI-RS resources and/or SSB resources and a CSI reference resource. The set of resources for channel measurement and the CSI reference resource may be collectively referred to as resources for channel prediction or channel prediction resources. The first apparatus 110 receives (620) the configuration of periodic or semi-persistent CSI report.

The first apparatus 110 determines (650) the CSI report based on the configuration. The determined CSI report may be transmitted to the second apparatus 120. For example, a scheduled channel such as PUSCH or PUCCH may carry the CSI report.

The CSI report occupies a first set of CPUs for a first time duration for channel measurement. The first time duration may be (pre) defined for the first apparatus 110. The first apparatus 110 may determine (630) the first time duration. The CSI report occupies a second set of CPUs for a second time duration for the inference. The first set of CPUs are different from the second set of CPUs. The second time duration is different from the first time duration. The second time duration may be (pre) defined for the first apparatus 110. The first apparatus 110 may determine (640) the second time duration.

In an embodiment, a starting time point of the second time duration may be a last symbol of a latest resource in a subset of the set of resources. The subset of resources are no later than the CSI reference resource. In another embodiment, a starting time point of the second time duration may be a time point prior to the last symbol of the latest resource.

In a further embodiment, a starting time point of the second time duration may be a last symbol of a first target occasion of a resource for channel measurement. The first apparatus 110 may determine that the first target occasion is no later than the CSI reference resource. By way of example, the first target occasion may be an M-th latest resource of the set of resources, M being a positive integer. M may be determined based on a configuration of the first target occasion from the second apparatus 120, a capability of the first apparatus 110, or an observation time window for the machine learning functionality. The machine learning functionality collects channel measurement results during the observation time window. For example, the second apparatus 120 may transmit, to the first apparatus 110, a configuration of at least one target occasion of at least one resource for channel measurement. The at least one target occasion may include the first target occasion, such as an index M of the first target occasion. In another embodiment, the first apparatus 110 may transmit, to the second apparatus 120, the capability information of the first apparatus 110 indicating the first target occasion.

In some embodiments, an ending time point of the second time duration may be a last symbol of a scheduled channel carrying the CSI report such as a scheduled PUSCH or PUCCH carrying the CSI report.

In some embodiments, he second time duration may include a first part for an activation of the machine learning functionality and a second part for the inference after the activation. A first number of CPUs may be occupied for the first part of the second time duration, while a second number of CPUs may be occupied for the second part of the second time duration.

In some embodiments, a starting time point of the first time duration may be a first symbol of an earliest resource of the set of resources, or a first symbol of a second target occasion of a resource for channel measurement. An occasion of the earliest resource or the second target occasion is no later than the CSI reference resource. The second target occasion may be determined based on a configuration from the second apparatus 120, capability information of the first apparatus 110, and/or the observation time window for the machine learning functionality.

In some embodiments, an ending time point of the first time duration may be a last symbol of the scheduled channel carrying the CSI report, a last symbol of a latest resource in a subset of the set of resources, or a last symbol of a latest occasion of the set of resources.

Several rules or parameters for determining the first time duration and the second time duration for P-CSI or SP-CSI report have been described. FIG. 7 illustrates an example diagram of CPU occupation for BM with P-CSI or SP-CSI reporting in accordance with some example embodiments of the present disclosure. As shown, an observation window 710 may be defined or configured for collecting channel measurements. A model inference time 720 may be defined or configured for the model inference based on the channel measurements. A prediction window 730 may be defined or configured for generating a prediction by the model. In such cases, the first time duration 740 may be from the first symbol of the earliest one of each CSI-RS/SSB resource, respective latest CSI-RS/SSB occasion no later than the corresponding CSI reference resource 760, until the last symbol of the configured PUSCH/PUCCH carrying the report. The second time duration 750 may be from the last symbol of the latest one of each CSI-RS/SSB resource, respective latest CSI-RS/SSB occasion no later than the corresponding CSI reference resource 760, until the last symbol of the scheduled PUSCH/PUCCH carrying the report. As shown, the last CSI-RS/SSB resource may be the CSI-RS/SSB resource 765 for the Set B.

It is to be understood that these example embodiments of the determination and definition of the first and second time durations are only for the purpose of illustration, without suggesting any limitation. For example, the first time duration may be from a second symbol or any other suitable symbol of the earliest one of each CSI-RS/SSB resource until a last symbol or a penultimate symbol of the scheduled PUSCH or PUCCH carrying the CSI report. These determinations and definitions of the first and second time durations may be adjusted in any suitable manner. Scope of the present disclosure is not limited here.

In some further embodiments, if the BM-Case2 is enabled by a periodic/semi-persistent CSI report, the CSI report occupies a first number of CPU(s) (O_{CPU,1}) for a first time duration. The first time duration may be from the first symbol of the earliest one of each CSI-RS/SSB resource, respective latest CSI-RS/SSB occasion no later than the corresponding CSI reference resource, until the last symbol of the configured PUSCH/PUCCH carrying the report. Similar to the AP-CSI-Report, O_{CPU,1} value may be assumed to be smaller or same as O_{CPU} considered for L1-RSRP reporting, where the UE considers CPUs mainly for L1-RSRP measurements.

In one variant, the CSI report occupies the first number of CPU(s) (O_{CPU,1}) from the first symbol of M^{th} latest consecutive periodic/semi-persistent CSI-RS occasions no later than CSI reference resource, until the last symbol of the scheduled PUSCH/PUCCH carrying the report. Similar to the AP-CSI-Report, M may be configured by the gNB, reported as the UE capability, or determined with respect to the observation time window for BM-Case2.

In another variant, the CSI report occupies the first number of CPU(s) (O_{CPU,1}) from the first symbol of M^{th} latest consecutive periodic/semi-persistent CSI-RS occasions no later than CSI reference resource, until the last symbol of the latest one of each CSI-RS/SSB resource, respective latest (1st latest) CSI-RS/SSB occasion no later than the corresponding CSI reference resource. Similar to the AP-CSI-Report, M may be configured by the gNB, reported as the UE capability, or determined with respect to the observation time window for BM-Case2.

The CSI report occupies a second number of CPU(s) (O_{CPU,2}) for a second time duration. The second time duration may be from the last symbol of the latest one of each CSI-RS/SSB resource, respective latest CSI-RS/SSB occasion no later than the corresponding CSI reference resource, until the last symbol of the scheduled PUSCH/PUCCH carrying the report. Similar to the AP-CSI-Report, O_{CPU,2} value may reflect CPU usage for ML model inference operation. The measurements (L1-RSRPs) are used for the inference operation.

In one variant, the CSI report occupies the second number of CPU(s) (O_{CPU,2}) from the last symbol of Nth latest consecutive periodic/semi-persistent CSI-RS occasions no later than CSI reference resource, until the last symbol of the scheduled PUSCH/PUCCH carrying the report. Similar to AP-CSI-Report, N may be configured by the gNB, reported as the UE capability, or determined with respect to the observation time window for BM-Case2.

In one variant, the second time duration may consist of more than one component, where one may be related to the model activation delay and an another may be related to the model inference after activation. In such cases, the second time duration may start prior to the last symbol of the latest one of each CSI-RS/SSB resource, respective latest CSI-RS/SSB occasion no later than the corresponding CSI reference resource. For example, the second time duration may start from the first symbol after the PDCCH triggering the CSI report. Here, one or two values for O_{CPU,2} may be assumed depending on whether timeline is for model activation or model inference.

It is also possible that only second time duration is defined to the UE. In such case, the first time duration may be not considered by the UE.

The CSI processing criteria may be adjusted based on the first and second time durations. The UE indicates the number of supported simultaneous CSI calculations N_{CPU} with parameter simultaneousCSI-ReportsPerCC in a component carrier, and simultaneousCSI-ReportsAIICC across all component carriers. If a UE supports N_{CPU} simultaneous CSI calculations it is said to have N_{CPU} CSI processing units for processing CSI reports. If L CPUs are occupied for calculation of CSI reports in a given OFDM symbol, the UE has N_{CPU}−L unoccupied CPUs. If N CSI reports start occupying their respective CPUs on the same OFDM symbol on which N_{CPU}−L CPUs are unoccupied, where each CSI report n=0, . . . , N−1 corresponds to

$${O}_{CPU}^{( n )} ,$$

the UE is not required to update the N−M requested CSI reports with lowest priority (according to Clause 5.2.5), where 0≤M≤N is the largest value such that

$${\sum }_{n = 0}^{M - 1} {O}_{CPU}^{( n )} \leq {N}_{CPU} - L$$

holds.

A UE is not expected to be configured with an aperiodic CSI trigger state containing more than N_{CPU} Reporting Settings. Processing of a CSI report occupies a number of CPUs for a number of symbols as follows:
O_{CPU}=0 for a CSI report with CSI-ReportConfig with higher layer parameter reportQuantity set to ‘none’ and CSI-RS-ResourceSet with higher layer parameter trs-Info configured.
O_{CPU}=1 for a CSI report with CSI-ReportConfig with higher layer parameter reportQuantity set to ‘cri-RSRP’, ‘ssb-Index-RSRP’, ‘cri-SINR’, ‘ssb-Index-SINR’, ‘cri-RSRP-Index’, ‘ssb-Index-RSRP-Index’, ‘cri-SINR-Index’, ‘ssb-Index-SINR-Index’ or ‘none’ (and CSI-RS-ResourceSet with higher layer parameter trs-Info not configured).
O_{CPU}=1 and O_{CPU,ML}=X for a CSI report with CSI-ReportConfig that configured with more than one measurement instance for the channel measurement resource set and configured to report, with higher layer parameter reportQuantity set to ‘cri-RSRP-N’, ‘ssb-Index-RSRP-N’, ‘cri-N’, or ‘ssb-Index-N’, corresponding to channel prediction resources.

For a CSI report with CSI-ReportConfig with higher layer parameter reportQuantity not set to ‘none’, the CPU(s) are occupied for a number of OFDM symbols as follows:
A periodic or semi-persistent CSI report (excluding an initial semi-persistent CSI report on PUSCH after the PDCCH triggering the report and an periodic or semi-persistent CSI report that carrying ‘cri-RSRP-N’, ‘ssb-Index-RSRP-N’, ‘cri-N’, or ‘ssb-Index-N’ corresponding to channel prediction resources on PUSCH/PUCCH) occupies CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the configured PUSCH/PUCCH carrying the report.
A periodic or semi-persistent CSI report that carrying ‘cri-RSRP-N’, ‘ssb-Index-RSRP-N’, ‘cri-N’, or ‘ssb-Index-N’ corresponding to channel prediction resources on PUSCH/PUCCH occupies first and second CPUs, the first CPUs, given by O_{CPU}, occupies from the first symbol of the earliest one of each CSI-RS/SSB resource for channel measurement, respective latest CSI-RS/SSB occasion no later than the corresponding CSI reference resource, until the last symbol of the configured PUSCH/PUCCH carrying the report and the second CPUs, given by O_{CPU,ML}, occupies from the last symbol of the latest one of each CSI-RS/SSB resource for channel measurement, respective latest CSI-RS/SSB occasion no later than the corresponding CSI reference resource, until the last symbol of the configured PUSCH/PUCCH carrying the report.
An aperiodic CSI report occupies CPU(s) from the first symbol after the PDCCH triggering the CSI report until the last symbol of the scheduled PUSCH carrying the report. When the PDCCH reception includes two PDCCH candidates from two respective search space sets, as described in clause 10.1 of [6, TS 38.213], for the purpose of determining the CPU occupation duration, the PDCCH candidate that ends later in time is used.
An initial semi-persistent CSI report on PUSCH after the PDCCH trigger occupies CPU(s) from the first symbol after the PDCCH until the last symbol of the scheduled PUSCH carrying the report. When the PDCCH reception includes two PDCCH candidates from two respective search space sets, as described in clause 10.1 of [6, TS 38.213], for the purpose of determining the CPU occupation duration, the PDCCH candidate that ends later in time is used.

Several embodiments for CPU time duration for inference for the P-CSI or SP-CSI reporting have been described. With these embodiments, the hardware utilization and allocation for CPU calculation can be optimized. The BM-Case2 with P-CSI or SP-CSI framework may be enhanced.

It is to be understood the parameters, values and rules for the first set of CPUs, the second set of CPUs, the first time duration and second time duration are only for the purpose of illustration, without suggesting any limitation. Those parameters, values or rules may be varied in some example embodiments. Scope of embodiments of the present disclosure is not limited here.

It would be appreciated that some example specifications, signaling flows and embodiments are provided above, and the detailed description may be varied. It is to be understood that these signaling flows 300, 400 and/or 600 may be used separately, or in any suitable combinations. Some example embodiments, operations or features described with respect to one of these signaling flows 300, 400 and/or 600 may be applied to another of these signaling flows. Part of one of these signaling flows 300, 400 and/or 600 may be applied in combination with part of another signaling flow. It is to be understood that these signaling flows 300, 400 and/or 600 may involve any other suitable operations or signaling not shown. With these signaling flows and similar signaling flows, the CSI processing framework for AI/ML enabled beam prediction in temporal domain can be enhanced.

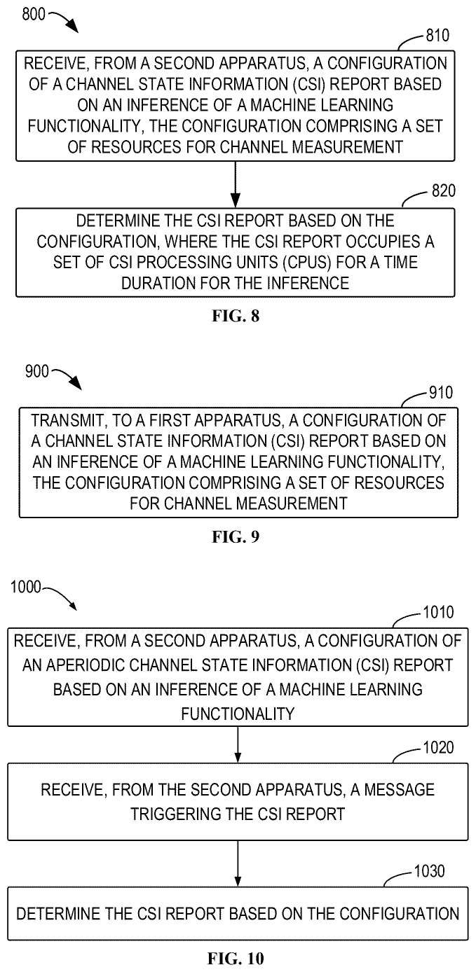

FIG. 8 shows a flowchart of an example method 800 implemented at a first apparatus in accordance with some example embodiments of the present disclosure. For the purpose of discussion, the method 800 will be described from the perspective of the first apparatus 110 in FIG. 1.

At block 810, the first apparatus 110 receives, from a second apparatus, a configuration of a CSI report based on an inference of a machine learning functionality. The configuration includes a set of resources for channel measurement.

At block 820, the first apparatus 110 determines the CSI report based on the configuration. The CSI report occupies a set of CPUs for a time duration for the inference.

In some example embodiments, the method 800 further comprises: determining a starting time point of the time duration based on at least one of: a latest resource or last symbol in a subset of the set of resources, a earliest resource or first symbol in a latest occasion of the set of resources, a latest resource or last symbol in the latest occasion of the set of resources, a symbol after a physical downlink control channel triggering the CSI report, or a latest resource or last symbol in a target occasion of a resource for channel measurement.

In some example embodiments, the method 800 further comprises: determining that at least one of the following is no later than a corresponding CSI reference resource: the subset of resources, the latest occasion of the set of resources, or the target occasion.

In some example embodiments, the method 800 further comprises: receiving, from the second apparatus, configuration information of the time duration for the inference, the configuration information indicating the target occasion.

In some example embodiments, the method 800 further comprises: transmitting, to the second apparatus, capability information of the first apparatus, the capability information indicating the target occasion.

In some example embodiments, the method 800 further comprises: determining the target occasion based on at least one of: an observation time window for the machine learning functionality, the machine learning functionality collecting channel measurement results during the observation time window.

In some example embodiments, the method 800 further comprises: determining an ending time point of the time duration based on at least one of: a scheduled physical uplink shared channel carrying the CSI report, or a scheduled physical uplink control channel carrying the CSI report.

In some example embodiments, the time duration comprises a first part for an activation of the machine learning functionality and a second part for the inference after the activation.

In some example embodiments, a first number of CPUs are occupied for the first part of the time duration, and a second number of CPUs are occupied for the second part of the time duration.

In some example embodiments, the CSI report further occupies a further set of CPUs for a further time duration for the channel measurement.

In some example embodiments, the method 800 further comprises: determining a starting time point of the further time duration based on at least one of: a physical downlink control channel triggering the CSI report, a further target occasion of a resource for channel measurement, the target occasion being no later than a corresponding CSI reference resource, or an earliest resource of the set of resources, an occasion of the earliest resource no later than the corresponding CSI reference resource.

In some example embodiments, the further target occasion is determined based on at least one of: a configuration from the second apparatus, capability information of the first apparatus, or an observation time window for the machine learning functionality, the machine learning functionality collecting channel measurement results during the observation time window.

In some example embodiments, the method 800 further comprises: determine an ending time point of the further time duration based on at least one of: a scheduled physical uplink shared channel carrying the CSI report, a latest resource in a subset of the set of resources, occasions of the subset of resources being no later than a corresponding CSI reference resource, or a latest occasion of the set of resources.

In some example embodiments, the CSI report comprises at least one of: an aperiodic CSI report, a periodic CSI report, or a semi-persistent CSI report.

FIG. 9 shows a flowchart of an example method 900 implemented at a second apparatus in accordance with some example embodiments of the present disclosure. For the purpose of discussion, the method 900 will be described from the perspective of the second apparatus 120 in FIG. 1.

At block 910, the second apparatus 120 transmits, to a first apparatus, a configuration of a CSI report based on an inference of a machine learning functionality. The configuration includes a set of resources for channel measurement. The CSI report occupies a set of CPUs of the first apparatus for a time duration for the inference.

In some example embodiments, the method 900 further comprises: transmitting, to the first apparatus, a configuration of a target occasion of a resource for channel measurement, where a starting time point of the time duration is determined based on the target occasion.

In some example embodiments, the method 900 further comprises: receiving, from the first apparatus, capability information of the first apparatus, the capability information indicating a target occasion of a resource for channel measurement, where a starting time point of the time duration is determined based on the target occasion.

In some example embodiments, the CSI report further occupies a further set of CPUs of the first apparatus for a further time duration for the channel measurement.

In some example embodiments, the method 900 further comprises: transmitting, to the first apparatus, a configuration of a further target occasion of a resource for channel measurement. A starting time point of the further time duration is determined based on the further target occasion.

In some example embodiments, the method 900 further comprises: receiving, from the first apparatus, capability information of the first apparatus, the capability information indicating a further target occasion of a resource for channel measurement. A starting time point of the further time duration is determined based on the further target occasion.

In some example embodiments, the CSI report comprises at least one of: an aperiodic CSI report, a periodic CSI report, or a semi-persistent CSI report.

FIG. 10 shows a flowchart of an example method 1000 implemented at a first apparatus in accordance with some example embodiments of the present disclosure. For the purpose of discussion, the method 1000 will be described from the perspective of the first apparatus 110 in FIG. 1.

At block 1010, the first apparatus 110 receives, from a second apparatus, a configuration of an aperiodic CSI report based on an inference of a machine learning functionality. The configuration includes a set of resources for channel measurement.

At block 1020, the first apparatus 110 receives, from the second apparatus, a message triggering the CSI report.

At block 1030, the first apparatus 110 determines the CSI report based on the configuration.

The CSI report occupies a first set of CPUs for a first time duration for channel measurement. The CSI report occupies a second set of CPUs for a second time duration for the inference. The first set of CPUs are different from the second set of CPUs. The second time duration is different from the first time duration.

In some example embodiments, a starting time point of the second time duration comprises one of: a last symbol of a latest resource in a subset of the set of resources, a latest resource or a last symbol of a latest occasion of the set of resources, an earliest resource or first symbol of the latest occasion of the set of resources, a first symbol after the message triggering the CSI report, or a last symbol of a first target occasion of a resource for channel measurement.

In some example embodiments, the method 1000 further comprises: determining that at least one of the following is no later than a corresponding CSI reference resource: the subset of resources, the latest occasion of the set of resources, or the target occasion.

In some example embodiments, the first target occasion comprises an M-th latest resource of the set of resources. M is a positive integer.

In some example embodiments, M is determined based on at least one of: a configuration of the first target occasion from the second network, a capability of the first apparatus, or an observation time window for the machine learning functionality, the machine learning functionality collecting channel measurement results during the observation time window.

In some example embodiments, an ending time point of the second time duration comprises a last symbol of a scheduled channel carrying the CSI report.

In some example embodiments, a starting time point of the first time duration comprises one of: a first symbol after the message triggering the CSI report, or a first symbol of a second target occasion of a resource for channel measurement.

In some example embodiments, the second target occasion is no later than a corresponding CSI reference resource.

In some example embodiments, the second target occasion is determined based on at least one of: a configuration from the second apparatus, capability information of the first apparatus, or an observation time window for the machine learning functionality, the machine learning functionality collecting channel measurement results during the observation time window.

In some example embodiments, an ending time point of the first time duration comprises one of: a last symbol of a scheduled channel carrying the CSI report, a last symbol of a latest resource in a subset of the set of resources, or a last symbol of a latest occasion of the set of resources.

In some example embodiments, occasions of the subset of resources are no later than a corresponding CSI reference resource.

In some example embodiments, the second time duration comprises a first part for an activation of the machine learning functionality and a second part for the inference after the activation.

In some example embodiments, a first number of CPUs are occupied for the first part of the second time duration, and a second number of CPUs are occupied for the second part of the second time duration.

In some example embodiments, the message triggering the CSI report comprises a physical downlink control channel triggering the CSI report.

In some example embodiments, a scheduled channel carrying the CSI report comprises a physical uplink shared channel carrying the CSI report.

In some example embodiments, the set of resources comprises a set of CSI reference signal (CSI RS) or synchronization signal block (SSB) resources.

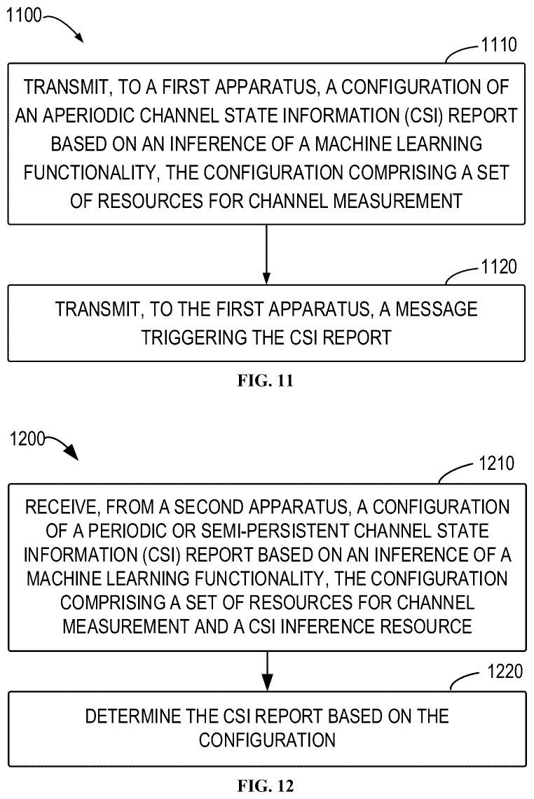

FIG. 11 shows a flowchart of an example method 1100 implemented at a second apparatus in accordance with some example embodiments of the present disclosure. For the purpose of discussion, the method 1100 will be described from the perspective of the second apparatus 120 in FIG. 1.

At block 1110, the second apparatus 120 transmits, to a first apparatus, a configuration of an aperiodic CSI report based on an inference of a machine learning functionality. The configuration includes a set of resources for channel measurement.

At block 1120, the second apparatus 120 transmits, to the first apparatus, a message triggering the CSI report,

The CSI report occupies a first set of CPUs of the first apparatus for a first time duration for channel measurement. The CSI report occupies a second set of CPUs of the first apparatus for a second time duration for the inference. The first set of CPUs are different from the second set of CPUs. The second time duration is different from the first time duration.

In some example embodiments, the method 1100 further comprises: transmitting, to the first apparatus, at least one of: a configuration of a first target occasion of a resource for channel measurement. A starting time point of the second time duration is determined based on the first target occasion, or a configuration of a second target occasion of a resource for channel measurement. A starting time point of the first time duration is determined based on the second target occasion.

In some example embodiments, the method 1100 further comprises: receiving, from the first apparatus, capability information of the first apparatus. The capability information indicates at least one of: a first target occasion of a resource for channel measurement, where a starting time point of the second time duration is determined based on the first target occasion, or a second target occasion of a resource for channel measurement, where a starting time point of the first time duration is determined based on the second target occasion.

FIG. 12 shows a flowchart of an example method 1200 implemented at a first apparatus in accordance with some example embodiments of the present disclosure. For the purpose of discussion, the method 1200 will be described from the perspective of the first apparatus 110 in FIG. 1.

At block 1210, the first apparatus 110 receives, from a second apparatus, a configuration of a periodic or semi-persistent CSI report based on an inference of a machine learning functionality. The configuration includes a set of resources for channel measurement and a CSI inference resource.

At block 1220, the first apparatus 110 determines the CSI report based on the configuration. The CSI report occupies a first set of CPUs for a first time duration for channel measurement. The CSI report occupies a second set of CPUs for a second time duration for the inference. The first set of CPUs are different from the second set of CPUs. The second time duration is different from the first time duration.

In some example embodiments, a starting time point of the second time duration comprises one of: a last symbol of a latest resource in a subset of the set of resources, a time point prior to the last symbol of the latest resource, or a last symbol of a first target occasion of a resource for channel measurement.

In some example embodiments, the method 1200 further comprises: determining that at least one of the following is no later than the CSI reference resource: the subset of resources, or the target occasion.

In some example embodiments, the first target occasion comprises an M-th latest resource of the set of resources, M being a positive integer.

In some example embodiments, M is determined based on at least one of: a configuration of the first target occasion from the second network, a capability of the first apparatus, or an observation time window for the machine learning functionality, the machine learning functionality collecting channel measurement results during the observation time window.

In some example embodiments, an ending time point of the second time duration comprises a last symbol of a scheduled channel carrying the CSI report.

In some example embodiments, a starting time point of the first time duration comprises one of: a first symbol of an earliest resource of the set of resources, or a first symbol of a second target occasion of a resource for channel measurement.

In some example embodiments, at least one of: an occasion of the earliest resource or the second target occasion is no later than the CSI reference resource.

In some example embodiments, the second target occasion is determined based on at least one of: a configuration from the second apparatus, capability information of the first apparatus, or an observation time window for the machine learning functionality. The machine learning functionality collects channel measurement results during the observation time window.

In some example embodiments, an ending time point of the first time duration comprises one of: a last symbol of the scheduled channel carrying the CSI report, a last symbol of a latest resource in a subset of the set of resources, or a last symbol of a latest occasion of the set of resources.

In some example embodiments, the second time duration comprises a first part for an activation of the machine learning functionality and a second part for the inference after the activation.

In some example embodiments, a first number of CPUs are occupied for the first part of the second time duration, and a second number of CPUs are occupied for the second part of the second time duration.

In some example embodiments, a scheduled channel carrying the CSI report comprises at least one of: a physical uplink shared channel carrying the CSI report, or a physical uplink control channel carrying the CSI report.

In some example embodiments, the set of resources comprises a set of CSI reference signal (CSI RS) or synchronization signal block (SSB) resources.

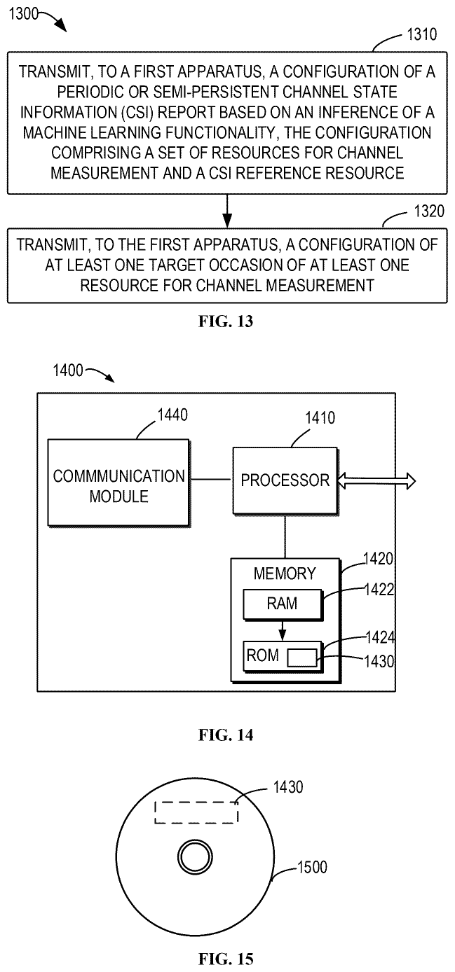

FIG. 13 shows a flowchart of an example method 1300 implemented at a second apparatus in accordance with some example embodiments of the present disclosure. For the purpose of discussion, the method 1300 will be described from the perspective of the second apparatus 120 in FIG. 1.

At block 1310, the second apparatus 120 transmits, to a first apparatus, a configuration of a periodic or semi-persistent CSI report based on an inference of a machine learning functionality. The configuration includes a set of resources for channel measurement and a CSI reference resource.

At block 1320, the second apparatus 120 transmits, to the first apparatus, a configuration of at least one target occasion of at least one resource for channel measurement. At least one of a first time duration or a second time duration is based on the configuration of the at least one target occasion.

The CSI report occupies a first set of CPUs of the first apparatus for the first time duration for channel measurement. The CSI report occupies a second set of CPUs of the first apparatus for the second time duration for the inference. The first set of CPUs are different from the second set of CPUs. The first time duration is different from the second time duration.

In some example embodiments, the method 1300 further comprises: receiving, from the first apparatus, capability information of the first apparatus. The capability information indicates at least one of: a first target occasion of a resource for channel measurement, where a starting time point of the second time duration is determined based on the first target occasion, or a second target occasion of a resource for channel measurement, where a starting time point of the first time duration is determined based on the second target occasion.

In some example embodiments, a first apparatus capable of performing any of the method 800 (for example, the first apparatus 110 in FIG. 1) may comprise means for performing the respective operations of the method 800. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a configuration of a CSI report based on an inference of a machine learning functionality, the configuration comprising a set of resources for channel measurement; and means for determining the CSI report based on the configuration. The CSI report occupies a set of CPUs for a time duration for the inference.

In some example embodiments, the first apparatus further comprises: means for determining a starting time point of the time duration based on at least one of: a latest resource or last symbol in a subset of the set of resources, a earliest resource or first symbol in a latest occasion of the set of resources, a latest resource or last symbol in the latest occasion of the set of resources, a symbol after a physical downlink control channel triggering the CSI report, or a latest resource or last symbol in a target occasion of a resource for channel measurement.

In some example embodiments, the first apparatus further comprises: means for determining that at least one of the following is no later than a corresponding CSI reference resource: the subset of resources, the latest occasion of the set of resources, or the target occasion.

In some example embodiments, the first apparatus further comprises: means for receiving, from the second apparatus, configuration information of the time duration for the inference, the configuration information indicating the target occasion.

In some example embodiments, the first apparatus further comprises: means for transmitting, to the second apparatus, capability information of the first apparatus, the capability information indicating the target occasion.

In some example embodiments, the first apparatus further comprises: means for determining the target occasion based on at least one of: an observation time window for the machine learning functionality, the machine learning functionality collecting channel measurement results during the observation time window.

In some example embodiments, the first apparatus further comprises: means for determining an ending time point of the time duration based on at least one of: a scheduled physical uplink shared channel carrying the CSI report, or a scheduled physical uplink control channel carrying the CSI report.

In some example embodiments, the time duration comprises a first part for an activation of the machine learning functionality and a second part for the inference after the activation.

In some example embodiments, a first number of CPUs are occupied for the first part of the time duration, and a second number of CPUs are occupied for the second part of the time duration.

In some example embodiments, the CSI report further occupies a further set of CPUs for a further time duration for the channel measurement.

In some example embodiments, the first apparatus further comprises: means for determining a starting time point of the further time duration based on at least one of: a physical downlink control channel triggering the CSI report, a further target occasion of a resource for channel measurement, the target occasion being no later than a corresponding CSI reference resource, or an earliest resource of the set of resources, an occasion of the earliest resource no later than the corresponding CSI reference resource.

In some example embodiments, the further target occasion is determined based on at least one of: a configuration from the second apparatus, capability information of the first apparatus, or an observation time window for the machine learning functionality, the machine learning functionality collecting channel measurement results during the observation time window.

In some example embodiments, the first apparatus further comprises: means for determining an ending time point of the further time duration based on at least one of: a scheduled physical uplink shared channel carrying the CSI report, a latest resource in a subset of the set of resources, occasions of the subset of resources being no later than a corresponding CSI reference resource, or a latest occasion of the set of resources.

In some example embodiments, the CSI report comprises at least one of: an aperiodic CSI report, a periodic CSI report, or a semi-persistent CSI report.

In some example embodiments, a second apparatus capable of performing any of the method 900 (for example, the second apparatus 120 in FIG. 1) may comprise means for performing the respective operations of the method 900. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a configuration of a CSI report based on an inference of a machine learning functionality, the configuration comprising a set of resources for channel measurement, where the CSI report occupies a set of CPUs of the first apparatus for a time duration for the inference.

In some example embodiments, the second apparatus further comprises: means for transmitting, to the first apparatus, a configuration of a target occasion of a resource for channel measurement, where a starting time point of the time duration is determined based on the target occasion.

In some example embodiments, the second apparatus further comprises: means for receiving, from the first apparatus, capability information of the first apparatus, the capability information indicating a target occasion of a resource for channel measurement, where a starting time point of the time duration is determined based on the target occasion.

In some example embodiments, the CSI report further occupies a further set of CPUs of the first apparatus for a further time duration for the channel measurement.

In some example embodiments, the second apparatus further comprises: means for transmitting, to the first apparatus, a configuration of a further target occasion of a resource for channel measurement, where a starting time point of the further time duration is determined based on the further target occasion.

In some example embodiments, the second apparatus further comprises: means for receiving, from the first apparatus, capability information of the first apparatus, the capability information indicating a further target occasion of a resource for channel measurement. A starting time point of the further time duration is determined based on the further target occasion.

In some example embodiments, the CSI report comprises at least one of: an aperiodic CSI report, a periodic CSI report, or a semi-persistent CSI report.

In some example embodiments, a first apparatus capable of performing any of the method 1000 (for example, the first apparatus 110 in FIG. 1) may comprise means for performing the respective operations of the method 1000. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a configuration of an aperiodic CSI report based on an inference of a machine learning functionality, the configuration comprising a set of resources for channel measurement; means for receiving, from the second apparatus, a message triggering the CSI report; and means for determining the CSI report based on the configuration, where the CSI report occupies a first set of CPUs for a first time duration for channel measurement, and where the CSI report occupies a second set of CPUs for a second time duration for the inference, the first set of CPUs being different from the second set of CPUs, and the second time duration being different from the first time duration.

In some example embodiments, a starting time point of the second time duration comprises one of: a last symbol of a latest resource in a subset of the set of resources, a latest resource or a last symbol of a latest occasion of the set of resources, an earliest resource or first symbol of the latest occasion of the set of resources, a first symbol after the message triggering the CSI report, or a last symbol of a first target occasion of a resource for channel measurement.

In some example embodiments, the first apparatus further comprises: means for determining that at least one of the following is no later than a corresponding CSI reference resource: the subset of resources, the latest occasion of the set of resources, or the target occasion. In some example embodiments, the first target occasion comprises an M-th latest resource of the set of resources, M being a positive integer.

In some example embodiments, M is determined based on at least one of: a configuration of the first target occasion from the second network, a capability of the first apparatus, or an observation time window for the machine learning functionality, the machine learning functionality collecting channel measurement results during the observation time window.

In some example embodiments, an ending time point of the second time duration comprises a last symbol of a scheduled channel carrying the CSI report.

In some example embodiments, a starting time point of the first time duration comprises one of: a first symbol after the message triggering the CSI report, or a first symbol of a second target occasion of a resource for channel measurement.

In some example embodiments, the second target occasion is no later than a corresponding CSI reference resource.

In some example embodiments, the second target occasion is determined based on at least one of: a configuration from the second apparatus, capability information of the first apparatus, or an observation time window for the machine learning functionality, the machine learning functionality collecting channel measurement results during the observation time window.

In some example embodiments, an ending time point of the first time duration comprises one of: a last symbol of a scheduled channel carrying the CSI report, a last symbol of a latest resource in a subset of the set of resources, or a last symbol of a latest occasion of the set of resources.

In some example embodiments, occasions of the subset of resources are no later than a corresponding CSI reference resource.

In some example embodiments, the second time duration comprises a first part for an activation of the machine learning functionality and a second part for the inference after the activation.

In some example embodiments, a first number of CPUs are occupied for the first part of the second time duration, and a second number of CPUs are occupied for the second part of the second time duration.

In some example embodiments, the message triggering the CSI report comprises a physical downlink control channel triggering the CSI report.

In some example embodiments, a scheduled channel carrying the CSI report comprises a physical uplink shared channel carrying the CSI report.

In some example embodiments, the set of resources comprises a set of CSI reference signal (CSI RS) or synchronization signal block (SSB) resources.

In some example embodiments, a second apparatus capable of performing any of the method 1100 (for example, the second apparatus 120 in FIG. 1) may comprise means for performing the respective operations of the method 1100. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a configuration of an aperiodic CSI report based on an inference of a machine learning functionality, the configuration comprising a set of resources for channel measurement; and means for transmitting, to the first apparatus, a message triggering the CSI report. The CSI report occupies a first set of CPUs of the first apparatus for a first time duration for channel measurement. The CSI report occupies a second set of CPUs of the first apparatus for a second time duration for the inference. The first set of CPUs are different from the second set of CPUs, and the second time duration is different from the first time duration.

In some example embodiments, the second apparatus further comprises: means for transmitting, to the first apparatus, at least one of: a configuration of a first target occasion of a resource for channel measurement, where a starting time point of the second time duration is determined based on the first target occasion, or a configuration of a second target occasion of a resource for channel measurement, where a starting time point of the first time duration is determined based on the second target occasion.

In some example embodiments, the second apparatus further comprises: means for receiving, from the first apparatus, capability information of the first apparatus. The capability information indicates at least one of: a first target occasion of a resource for channel measurement, where a starting time point of the second time duration is determined based on the first target occasion, or a second target occasion of a resource for channel measurement, where a starting time point of the first time duration is determined based on the second target occasion.

In some example embodiments, a first apparatus capable of performing any of the method 1200 (for example, the first apparatus 110 in FIG. 1) may comprise means for performing the respective operations of the method 1200. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a configuration of a periodic or semi-persistent CSI report based on an inference of a machine learning functionality, the configuration comprising a set of resources for channel measurement and a CSI inference resource; and means for determining the CSI report based on the configuration, where the CSI report occupies a first set of CPUs for a first time duration for channel measurement, and where the CSI report occupies a second set of CPUs for a second time duration for the inference, the first set of CPUs being different from the second set of CPUs, and the second time duration being different from the first time duration.

In some example embodiments, a starting time point of the second time duration comprises one of: a last symbol of a latest resource in a subset of the set of resources, a time point prior to the last symbol of the latest resource, or a last symbol of a first target occasion of a resource for channel measurement.

In some example embodiments, the first apparatus further comprises: means for determining that at least one of the following is no later than the CSI reference resource: the subset of resources, or the target occasion.

In some example embodiments, the first target occasion comprises an M-th latest resource of the set of resources, M being a positive integer.

In some example embodiments, M is determined based on at least one of: a configuration of the first target occasion from the second network, a capability of the first apparatus, or an observation time window for the machine learning functionality, the machine learning functionality collecting channel measurement results during the observation time window.

In some example embodiments, an ending time point of the second time duration comprises a last symbol of a scheduled channel carrying the CSI report.

In some example embodiments, a starting time point of the first time duration comprises one of: a first symbol of an earliest resource of the set of resources, or a first symbol of a second target occasion of a resource for channel measurement.

In some example embodiments, at least one of: an occasion of the earliest resource or the second target occasion is no later than the CSI reference resource.

In some example embodiments, the second target occasion is determined based on at least one of: a configuration from the second apparatus, capability information of the first apparatus, or an observation time window for the machine learning functionality, the machine learning functionality collecting channel measurement results during the observation time window.

In some example embodiments, an ending time point of the first time duration comprises one of: a last symbol of the scheduled channel carrying the CSI report, a last symbol of a latest resource in a subset of the set of resources, or a last symbol of a latest occasion of the set of resources.

In some example embodiments, the second time duration comprises a first part for an activation of the machine learning functionality and a second part for the inference after the activation.

In some example embodiments, a first number of CPUs are occupied for the first part of the second time duration, and a second number of CPUs are occupied for the second part of the second time duration.

In some example embodiments, a scheduled channel carrying the CSI report comprises at least one of: a physical uplink shared channel carrying the CSI report, or a physical uplink control channel carrying the CSI report.

In some example embodiments, the set of resources comprises a set of CSI reference signal (CSI RS) or synchronization signal block (SSB) resources.

In some example embodiments, a second apparatus capable of performing any of the method 1300 (for example, the second apparatus 120 in FIG. 1) may comprise means for performing the respective operations of the method 1300. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a configuration of a periodic or semi-persistent CSI report based on an inference of a machine learning functionality, the configuration comprising a set of resources for channel measurement and a CSI reference resource; and means for transmitting, to the first apparatus, a configuration of at least one target occasion of at least one resource for channel measurement. At least one of a first time duration or a second time duration is based on the configuration of the at least one target occasion. The CSI report occupies a first set of CPUs of the first apparatus for the first time duration for channel measurement. The CSI report occupies a second set of CPUs of the first apparatus for the second time duration for the inference.

In some example embodiments, the second apparatus further comprises: means for receiving, from the first apparatus, capability information of the first apparatus, the capability information indicating at least one of: a first target occasion of a resource for channel measurement, where a starting time point of the second time duration is determined based on the first target occasion, or a second target occasion of a resource for channel measurement, where a starting time point of the first time duration is determined based on the second target occasion.

FIG. 14 is a simplified block diagram of a device 1400 that is suitable for implementing example embodiments of the present disclosure. The device 1400 may be provided to implement a communication device, for example, the first apparatus 110 or the second apparatus 120 as shown in FIG. 1. As shown, the device 1400 includes one or more processors 1410, one or more memories 1420 coupled to the processor 1410, and one or more communication modules 1440 coupled to the processor 1410.

The communication module 1440 is for bidirectional communications. The communication module 1440 has one or more communication interfaces to facilitate communication with one or more other modules or devices. The communication interfaces may represent any interface that is necessary for communication with other network elements. In some example embodiments, the communication module 1440 may include at least one antenna.

The processor 1410 may be of any type suitable to the local technical network and may include one or more of the following: general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

The memory 1420 may include one or more non-volatile memories and one or more volatile memories. Examples of the non-volatile memories include, but are not limited to, a Read Only Memory (ROM) 1424, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 1422 and other volatile memories that will not last in the power-down duration.

A computer program 1430 includes computer executable instructions that are executed by the associated processor 1410. The instructions of the program 1430 may include instructions for performing operations/acts of some example embodiments of the present disclosure. The program 1430 may be stored in the memory, e.g., the ROM 1424. The processor 1410 may perform any suitable actions and processing by loading the program 1430 into the RAM 1422.

The example embodiments of the present disclosure may be implemented by means of the program 1430 so that the device 1400 may perform any process of the disclosure as discussed with reference to FIG. 3 to FIG. 13. The example embodiments of the present disclosure may also be implemented by hardware or by a combination of software and hardware.

In some example embodiments, the program 1430 may be tangibly contained in a computer readable medium which may be included in the device 1400 (such as in the memory 1420) or other storage devices that are accessible by the device 1400. The device 1400 may load the program 1430 from the computer readable medium to the RAM 1422 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. BBBB shows an example of the computer readable medium BBBB00 which may be in form of CD, DVD or other optical storage disk. The computer readable medium BBBB00 has the program 1430 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus to:
receive, from a second apparatus, a configuration of a channel state information (CSI) report based on an inference of a machine learning functionality, the configuration comprising a set of resources for channel measurement; and
determine the CSI report based on the configuration, wherein the CSI report occupies a set of CSI processing units (CPUs) for a time duration for the inference.

2. The first apparatus of claim 1, wherein the first apparatus is further caused to: determine a starting time point of the time duration as a first symbol after a physical downlink control channel triggering the CSI report.

3. The first apparatus of claim 1, wherein the first apparatus is further caused to:
determine an ending time point of the time duration based on at least one of: a scheduled physical uplink shared channel carrying the CSI report, or a scheduled physical uplink control channel carrying the CSI report.

4. The first apparatus of claim 1, wherein the first apparatus is further caused to: determine a starting time point of the time duration based on at least one of:
a latest resource or last symbol in a subset of the set of resources,
an earliest resource or first symbol in a latest occasion of the set of resources,
a latest resource or last symbol in the latest occasion of the set of resources,
a latest resource or last symbol in a target occasion of a resource for channel measurement.

5. The first apparatus of claim 4, wherein the first apparatus is further caused to:
determine that at least one of the following is no later than a corresponding CSI reference resource: the subset of resources, the latest occasion of the set of resources, or the target occasion.

6. The first apparatus of claim 4, wherein the first apparatus is further caused to:
receive, from the second apparatus, configuration information of the time duration for the inference, the configuration information indicating the target occasion.

7. The first apparatus of claim 4, wherein the first apparatus is further caused to:
transmit, to the second apparatus, capability information of the first apparatus, the capability information indicating the target occasion.

8. The first apparatus of claim 4, wherein the first apparatus is further caused to:
determine the target occasion based on an observation time window for the machine learning functionality, the machine learning functionality collecting channel measurement results during the observation time window.

9. The first apparatus of claim 1, wherein the CSI report further occupies a further set of CPUs for a further time duration for the channel measurement.

10. The first apparatus of claim 1, wherein the time duration for the inference occupies a second number of CPU(s) (O_{CPU,2}) from a first symbol after the PDCCH triggering the CSI report, until a last symbol of a scheduled PUSCH carrying the report.

11. The first apparatus of claim 10, wherein O_{CPU,2} indicates a CPU usage for ML model inference operation.

12. The first apparatus of claim 10, wherein O_{CPU,2} distinct from a first CPU usage for L1-RSRP reporting (O_{CPU}) defined at the apparatus.

13. The first apparatus of claim 1, wherein the time duration for the inference defined for beam prediction in the time domain.

14. A second apparatus comprising:
at least one processor; and
at least one memory storing instructions that, when executed by the at least one processor, cause the second apparatus to:
transmit, to a first apparatus, a configuration of a channel state information (CSI) report based on an inference of a machine learning functionality, the configuration comprising a set of resources for channel measurement,
wherein the CSI report occupies a set of CSI processing units (CPUs) of the first apparatus for a time duration for the inference.

15. The second apparatus of claim 14, wherein the second apparatus is further caused to:
transmit, to the first apparatus, configuration information of a target occasion of a resource for channel measurement, wherein a starting time point of the time duration is determined based on the target occasion.

16. The second apparatus of claim 14, wherein the second apparatus is further caused to:
receive, from the first apparatus, capability information of the first apparatus, the capability information indicating a target occasion of a resource for channel measurement, wherein a starting time point of the time duration is determined based on the target occasion.

17. The second apparatus of claim 14, wherein the CSI report further occupies a further set of CPUs of the first apparatus for a further time duration for the channel measurement.

18. The second apparatus of claim 17, wherein the second apparatus is further caused to:
transmit, to the first apparatus, configuration information of a further target occasion of a resource for channel measurement, wherein a starting time point of the further time duration is determined based on the further target occasion.

19. The second apparatus of claim 17, wherein the second apparatus is further caused to:
receive, from the first apparatus, capability information of the first apparatus, the capability information indicating a further target occasion of a resource for channel measurement, wherein a starting time point of the further time duration is determined based on the further target occasion.

20. A method comprising:
receiving, at a first apparatus from a second apparatus, a configuration of a channel state information (CSI) report based on an inference of a machine learning functionality, the configuration comprising a set of resources for channel measurement; and
determining the CSI report based on the configuration, wherein the CSI report occupies a set of CSI processing units (CPUs) for a time duration for the inference.
